(19) United States
(12) Patent Application Publication
(10) Pub. No.: US 2020/0210956 A1
(43) Pub. Date: Jul. 2, 2020

(54) ELECTRONIC REGISTERED MAIL METHODS, APPARATUS, AND SYSTEM

(71) Applicants: Guillaume de Malzac de Sengla, Paris (FR); Clement Schneider, La Wantzenau (FR)

(72) Inventors: Guillaume de Malzac de Sengla, Paris (FR); Clement Schneider, La Wantzenau (FR)

(21) Appl. No.: 16/729,847

(22) Filed: Dec. 30, 2019

Related U.S. Application Data
(60) Provisional application No. 62/786,032, filed on Dec. 28, 2018.

(51) Int. Cl. G06Q 10/10; H04L 12/58; H04L 29/06

(52) U.S. Cl. CPC G06Q 10/107; H04L 51/12; H04L 63/12; H04L 51/14; H04L 51/066; H04L 51/28

(57) ABSTRACT

A method, apparatus, and system for providing electronic registered mail (“ERM”) are disclosed. An example apparatus includes an interface to receive, from a sender server, recipient information for creating ERM for sending to a recipient and ERM content for the ERM. The apparatus also includes a processor that creates an ERM notification message for the recipient by including a recipient name, a recipient physical address, and instructions for verification of the recipient, and transmits the ERM notification message to a recipient email address. The processor later receives verification information from a user device of the recipient, and compares the verification information to at least some of the recipient information. If the comparison is positive, the processor causes the ERM content to be provided to the recipient. However, if the comparison is negative, the processor prevents the ERM content from being provided to the recipient.

### PRIORITY CLAIM

This application claims priority to and the benefit as a non-provisional application of U.S. Provisional Patent Application No. 62/786,032, filed Dec. 28, 2018, the entire contents of which are hereby incorporated by reference and relied upon.

### BACKGROUND

Electronic registered mail (“ERM”) permits a sender to transmit sensitive documents or information to a recipient without the threat of interception by a third-party. While not used in the United States, ERM is typically used in Europe for legal documents, government-issued documents, personal information, confidential information, and other important documents that require a recipient's signature and/or verification for receipt. In some instances, a recipient receives a notification email of an ERM with links or instructions for providing verification. Once verification of the recipient is received by the system, the recipient is provided access to the contents of the ERM via a hyperlink to a website, electronic payment provider, web form, or other electronic location. In some instances, another email is provided after a recipient has been verified.

ERM systems require a recipient to verify themselves in a number of different ways. In some instances, verification is provided by the recipient having a proprietary email account. In other instances, verification is provided via an electronic identification (“ID”) card or a physical ID card shown by a recipient to a camera. In yet other instances, verification of a recipient's identity is provided by a notary or other sworn agent, which then provides the recipient with login credentials to access the documents or information. While these different methods are compliant with European Union (“EU”) regulations, including qualification requirements, such as the Electronic Identification, Authentication and trust Services (“eIDAS”), the different methods are generally cumbersome for recipients to provide verification. For instance, recipients would rather avoid having to obtain an electronic ID card, set up a proprietary email account, or visit a notary, especially if the recipient is not accustomed to receiving electronic registered mail. As a result of these difficulties, many recipients disregard notices about receiving electronic registered mail, thereby frustrating senders and sometimes causing them to resort to physical registered mail.

### SUMMARY

The present disclosure is directed to a system, method, and apparatus configured for managing the transmission, verification, and fulfillment of ERM. The example system, method, and apparatus disclosed herein are configured to make it easier for a recipient to provide verification, thereby increasing user acceptance and satisfaction of the ERM process. In some embodiments, the system, method, and apparatus are configured to conform to United States state or local (or European national) rules and regulations for lien notification. Further, the example system, method, and apparatus disclosed herein provide tracking of a service provider's delinquent accounts. The tracking may include delivery status of an ERM and an identification of one or more subsequent steps that must be taken to properly apply a lien to a recipient.

In an example, the system, method, and apparatus disclosed herein provide a unique workflow for lien notification using an ERM process that generates and stores copies of ERMs as evidence as to whether a lien was received/viewed by the intended recipient. The system, method, and apparatus may also provide subsequent lien notification follow up documentation or alternative notifications to ensure a service provider adheres to the proper jurisdictional requirements. In some examples, the ERM disclosed herein includes links or other embedded features for a recipient. The embedded features may enable a recipient to verify their identity, make a payment, or access a website, web form, short message service (“SMS”) application, etc. to communicate with a sender of the ERM.

In addition to above, the example system, method, and apparatus are configured to address known issues with ERM. For instance, many known ERM systems are relatively rigid regarding a recipient's name. These systems often require that a user's name as entered by the sender match exactly a name entered or provided by the recipient when identifying themselves. Oftentimes, this is not the case and the recipient will provide a name that varies slightly from the name provided by the sender. This occurs not only because of perpetual typos, but also frequently in cultures that use many non-standard English characters, accents, and compounded first, middle, and/or last names. This also occurs frequently when ERM is transmitted between people/organizations of different linguistic structures in which the sender may not appreciate the finer details or features in a recipient's name. This can also occur frequently in locations where the use of nicknames is more prevalent and used with legal or government-related documents. As a result of this name mismatch, known ERM systems are configured to reject a recipient and prevent the registered mail from being delivered.

The example system, methods, and apparatus disclosed herein, in some embodiments, are configured to operate a name matching algorithm that determines a degree of matching between a name provided by a sender and a name provided by a recipient. The degree of matching may be compared to one or more thresholds. If a degree of matching is below a threshold, the example system, methods, and apparatus are configured to enable a recipient to enter their name, such as a legal name instead of outright rejecting the transaction. The example system, methods, and apparatus are configured to transmit a name notification to the ERM sender that indicates a name change provided by the recipient. The ERM sender may accept or reject the proposed name change. The example system, methods, and apparatus are configured to receive a response notification from the sender indicative as to whether they have accepted the name provided by the recipient, or have provided an alternative name. If the response notification is indicative of an acceptance of a change to the recipient's name, the example system, methods, and apparatus are configured to update the verification criteria for the ERM with the new recipient name. The example system, methods, and apparatus disclosed herein accordingly enable a recipient to provide ample verification to receive their ERM despite an initial mismatch between names.

The example system, methods, and apparatus disclosed herein may use a number of different thresholds for determining a name mismatch between a recipient and a sender. In an embodiment, the threshold may be a single specified value. In other embodiments, the system, methods, and apparatus may use a different threshold for first, middle, and last names. Additionally or alternatively, the system, methods, and apparatus may adjust a threshold or a matching weight based on individual characters or certain groups of characters. For instance, standard alpha-numeric characters may have a first matching weight while special characters or characters with marks have a second lower matching weight. Further, the system, methods, and apparatus may group certain characters together such that reception of at least one character in the group constitutes a match for that character. In yet other embodiments, the system, methods, and apparatus may adjust thresholds based on language and/or a culture of the sender/recipient and/or a compatibility rating between a language/culture of the sender/recipient. Moreover, the system, methods, and apparatus may be configured to permit a sender to specify a threshold for matching, such as a rigid threshold, medium threshold, or loose threshed.

The example system, methods, and apparatus disclosed herein may also be configured to provide for multiple options for recipient verification. The multiple options may include an option for live or near-real time verification, an option for automated verification, or a combination thereof. For live or near-real time verification, the example system, methods, and apparatus are configured to electronically connect a recipient to an individual tasked with performing verification. In some instances, the system may record a recipient for later verification by the individual. During the connection session, the recipient is prompted to enable a camera to record one or more images of their face and/or prompted to show an ID card, such as a driver's license or passport. The example system, methods, and apparatus may use image capture and/or OCR to extract text from the ID card to assist the individual performing the verification.

For automated verification, the system, methods, and apparatus disclosed herein are configured to prompt a user to record an image of their ID card. The system, methods, and apparatus may cause a barcode or QR code to be displayed on a screen or printed, and prompt the recipient to record the image of their ID card next to the QR code or barcode. This ensures the image provided by the recipient is current and not recorded. In some embodiments, the recipient may link both a mobile device and a device connected to a computer screen to a system for performing the verification such that the QR code can be displayed by the screen to enable the mobile device to record and transmit back the image with the QR code and ID card, which is linked to the same session. The recipient may also be prompted to record an image (or short video) of themselves, which may also include an image of themselves next to the computer screen or printout of the QR code or barcode. In some instances, the system, methods, and apparatus prompt the recipient to perform a specific action, such as moving their head in a certain manner or saying a specific phrase/word. The example system, methods, and apparatus may then perform verification by using face matching algorithms between the image of the recipient, an image in the ID card, and/or images in a database. The example system, methods, and apparatus may also use movement recognition and/or voice-to-text recognition to confirm the recipient acted as prompted. Additionally or alternatively, the system, methods, and apparatus may perform verification by comparing information in the ID card, such as a recipient's name and/or address to information provided by the sender or stored in a database.

Aspects of the subject matter described herein may be useful alone or in combination with one or more other aspect described herein. Without limiting the foregoing description, in a first aspect of the present disclosure, an electronic registered mail (“ERM”) apparatus includes at least one interface configured to receive, from a sender server, (i) recipient information for creating ERM for sending to a recipient, (ii) ERM content for the ERM, and (iii) at least one verification option. The recipient information includes a recipient name, a recipient physical address, and a recipient email address. The example ERM apparatus also includes a processor communicatively coupled to the at least one interface. The processor is configured to create an ERM notification message for the recipient by including the recipient name, the recipient physical address, and instructions for verification of the recipient based on the selected at least one verification option. The processor is also configured to store a copy of the ERM to a memory device including at least one of the ERM notification message or the ERM content, and transmit the ERM notification message to the recipient email address. The processor is further configured to receive verification information from a user device that accesses an email application for the recipient email address, and compare the verification information to at least some of the recipient information provided by the sender server or a unique code. If the comparison is positive, the processor is configured to cause the ERM content to be provided to the recipient. If the comparison is negative, the processor is configured to prevent the ERM content from being provided to the recipient.

In accordance with a second aspect of the present disclosure, which may be used in combination with any other aspect listed herein unless stated otherwise, the ERM content includes at least one of a message, confidential information, a lien notification, legal information, personal information, an image, a video, or a hyperlink to a payment processor online system, a website, web form, or a server.

In accordance with a third aspect of the present disclosure, which may be used in combination with any other aspect listed herein unless stated otherwise, the processor is configured to include the ERM content with the ERM notification message and cause the ERM content to made available or unlocked if the comparison is positive.

In accordance with a fourth aspect of the present disclosure, which may be used in combination with any other aspect listed herein unless stated otherwise, the processor is configured to provide the ERM content separately from the ERM notification message and transmit at least one message with the ERM content to the email address of the recipient if the comparison is positive.

In accordance with a fifth aspect of the present disclosure, which may be used in combination with any other aspect listed herein unless stated otherwise, the processor is configured to store a record of the comparison in relation to the copy of the ERM in the memory device.

In accordance with a sixth aspect of the present disclosure, which may be used in combination with any other aspect listed herein unless stated otherwise, the processor is configured to transmit a message to the sender server that is indicative of the comparison or indicative as to whether the ERM content was provided to the recipient.

In accordance with a seventh aspect of the present disclosure, which may be used in combination with any other aspect listed herein unless stated otherwise, the at least one verification option includes at least one of receiving a code from a notary, recording an image of an identification card, recording video of the recipient holding an identification card, or live verification by an operator.

In accordance with an eighth aspect of the present disclosure, which may be used in combination with any other aspect listed herein unless stated otherwise, the processor is configured to include a verification submission feature with the ERM notification message, the submission feature configured based on the selected at least one verification option.

In accordance with a ninth aspect of the present disclosure, which may be used in combination with any other aspect listed herein unless stated otherwise, (a) selection of the verification submission feature for the code from the notary causes the ERM notification message to open an interface on the user device with at least one field to accept the code from the notary for submission of the verification information, (b) selection of the verification submission feature for recording the image of the identification card causes the ERM notification message to open an interface on the user device with at least one field to accept a recorded image of the identification card of the recipient for submission of the verification information, (c) selection of the verification submission feature for recording the video of the recipient holding the identification card causes the ERM notification message to open an interface on the user device that provides instructions for the recipient to perform while being recorded and includes at least one field to accept the recorded video of the identification card of the recipient for submission of the verification information, and (d) selection of the verification submission feature for the live verification by an operator causes the ERM notification message to open an interface on the user device with a communication connection to an operator terminal that provides the verification information after the recipient has satisfied requests of the operator or the operator terminal provides the recipient the code for submission as the verification information.

In accordance with a tenth aspect of the present disclosure, which may be used in combination with any other aspect listed herein unless stated otherwise, the processor is configured to compare the verification information to at least some of the recipient information by performing at least one of a name recognition algorithm or a physical address recognition algorithm, if a degree of similarity provided by the at least one of a name recognition algorithm or the physical address recognition algorithm is above a threshold, determine the comparison is positive, and if the degree of similarity provided by the at least one of a name recognition algorithm or the physical address recognition algorithm is below the threshold, determine the comparison is negative.

In accordance with an eleventh aspect of the present disclosure, which may be used in combination with any other aspect listed herein unless stated otherwise, the at least one of the name recognition algorithm or the physical address recognition algorithm includes at least one of a programming classics method for comparing characters, a Levenshtein method that determines a minimal number of characters needed to be replaced to create a match, an inclusion method that searches for name prefixes such as Mr. or Dr., an inversion of words method, an inversion of fields method, or combinations thereof to determine the degree of similarity between at least one of the recipient name and the recipient physical address.

In accordance with a twelfth aspect of the present disclosure, which may be used in combination with any other aspect listed herein unless stated otherwise, the processor is configured to include a name change option in the ERM notification message, receive from the user device after selection of the name change option, an amended recipient name, transmit a message to the sender server that is indicative of the amended recipient name, if an approval message is received from the sender server, create a second ERM including a second ERM notification message with the amended recipient name, and transmit the second ERM notification message with the amended recipient name to the recipient email address.

In accordance with a thirteenth aspect of the present disclosure, which may be used in combination with any other aspect listed herein unless stated otherwise, the ERM content includes a lien notice or a lien to sale notice.

In accordance with a fourteenth aspect of the present disclosure, which may be used in combination with any other aspect listed herein unless stated otherwise, an electronic registered mail (“ERM”) apparatus for lien notifications includes at least one interface configured to receive, from a sender server, (i) recipient information for creating ERM for sending to a recipient, (ii) overdue account information, and (iii) at least one verification option. The recipient information includes a recipient name, a recipient physical address, and a recipient email address. The ERM apparatus also includes a memory device storing template forms for lien notices and coding for jurisdictional rules regarding lien notices and a processor communicatively coupled to the at least one interface and the memory device. The processor is configured to determine a jurisdiction related to the recipient or the account of the recipient, determine a lien notice is to be generated based on the coding for jurisdictional rules that are related to the determined jurisdiction and the overdue account information, and generate the lien notice for the recipient. The processor is also configured to create an ERM notification message for the recipient by including the recipient name, the recipient physical address, and instructions for verification of the recipient based on the selected at least one option, and transmit the ERM message notification to the recipient email address. The processor is further configured to receive verification information from a user device that accesses an email application for the recipient email address and views the ERM notification message, and compare the verification information to at least some of the recipient information provided by the sender server or a unique code. If the comparison is positive, the processor is configured to cause the lien notice to be provided electronically to the recipient. If the comparison is negative, the processor is configured to cause the lien notice to be physically mailed to the recipient physical address.

In accordance with a fifteenth aspect of the present disclosure, which may be used in combination with any other aspect listed herein unless stated otherwise, the processor is configured to include the lien notice with the ERM notification message and cause the lien notice to be unlocked if the comparison is positive.

In accordance with a sixteenth aspect of the present disclosure, which may be used in combination with any other aspect listed herein unless stated otherwise, the processor is configured to provide the lien notice separately from the ERM notification message and transmit at least one message with the lien notice to the email address of the recipient if the comparison is positive.

In accordance with a seventeenth aspect of the present disclosure, which may be used in combination with any other aspect listed herein unless stated otherwise, the processor is configured to include a hyperlink to a payment processor in the lien notice, after causing the lien notice to be provided to the recipient, receive an indication of a payment from the payment processor, and update the overdue account information to reflect the payment by the recipient.

In accordance with an eighteenth aspect of the present disclosure, which may be used in combination with any other aspect listed herein unless stated otherwise, the processor is configured to transmit a payment message to the sender server that is indicative of the payment.

In accordance with a nineteenth aspect of the present disclosure, which may be used in combination with any other aspect listed herein unless stated otherwise, the processor is configured to include a feature to initiate communication via at least one of a text message program, an email message program, or a phone program in the lien notice, after causing the lien notice to be provided to the recipient, receive from the user device a communication via the at least one of the text message program, the email program, or the phone program, and route the communication to an account or a queue of an operator for responding.

In accordance with a twentieth aspect of the present disclosure, which may be used in combination with any other aspect listed herein unless stated otherwise, the processor is configured to include a name change option in the ERM notification message, receive from the user device after selection of the name change option, an amended recipient name, transmit a message to the sender server that is indicative of the amended recipient name, and if an approval message is received from the sender server, verify the recipient or a substitute recipient using the received verification information and the amended recipient name.

In a twenty-first aspect of the present disclosure, any of the structure and functionality disclosed in connection with FIGS. 1 to 20 may be combined with any other structure and functionality disclosed in connection with FIGS. 1 to 20.

In light of the present disclosure and the above aspects, it is therefore an advantage of the present disclosure to provide a system that verifies a recipient's identity for electronic delivery of ERM.

It is another advantage of the present disclosure to unlock ERM content upon verification of a recipient's identity.

It is yet another advantage of the present disclosure to provide for name or address changes of a recipient or substitute recipient for ERM.

It is a further advantage of the present disclosure to provide lien notifications using ERM to confirm to jurisdictional rules or regulations.

The advantages discussed herein may be found in one, or some, and perhaps not all of the embodiments disclosed herein. Additional features and advantages are described herein, and will be apparent from the following Detailed Description and the figures.

### BRIEF DESCRIPTION OF THE FIGURES

FIG. 1 shows an example system for ERM management, according to an example embodiment of the present disclosure.

FIG. 2 shows a diagram of the ERM system of FIG. 1 illustrating an embodiment for recipient verification, according to an example embodiment of the present disclosure.

FIG. 3 shows a diagram of information that may be provided by a recipient for verification, according to an example embodiment of the present disclosure.

FIG. 4 shows a diagram of an example procedure for providing ERM verification, according to an example embodiment of the present disclosure.

FIGS. 5 to 12 shows diagrams related to the ERM verification procedure of FIG. 4, according to an example embodiment of the present disclosure.

FIG. 13 shows a diagram of the management server of FIGS. 1 and 2 configured to provide lien notifications, according to an example embodiment of the present disclosure.

FIG. 14 shows a diagram of a procedure for providing lien notifications using ERM using the management server of FIG. 13, according to an example embodiment of the present disclosure.

FIG. 15 shows a diagram of a dashboard of overdue accounts, according to an example embodiment of the present disclosure.

FIGS. 16 to 20 show diagrams of forms related to lien notifications, according to example embodiments of the present disclosure.

### DETAILED DESCRIPTION

The present disclosure relates in general to a method, system, and apparatus configured to manage the creation, verification, and fulfillment of electronic registered mail (“ERM”). The method, system, and apparatus disclosed herein are configured to be compliant with national and regional regulations, including elDAS, while providing verification flexibility that increases usage and acceptance by recipients of ERM. As disclosed in more detail below, verification flexibility includes features that enable dynamic name and/or address matching between a sender and a recipient, features that enable a recipient to change a spelling of their name and/or address, features that enable a recipient to specify a substitute recipient, and/or features that provide for options of live, near-real time, or automated verification of information provided by a recipient. In instances where a recipient requests a substitute recipient, name change, and/or address change, sender approval is usually required unless the sender as preapproved such changes. After sender approval, the method, system, and apparatus may verify the recipient or the substitute recipient without reverification if sufficient verification information was provided at the time of the name/address change request.

As discussed below, ERM includes one or more electronic messages created by a sender to convey personal and/or sensitive information to a recipient. The ERM may be used to provide a legal notice or a notice from a government organization. The ERM may also be used to convey sensitive, confidential, or personal information. In some applications ERM may be used to convey bank account information, social security numbers, personal medical information, or any other information in which an extra layer of security is prudent. Further, ERM may be used to serve lien notifications or other types of notifications, where the ERM provides legal evidence regarding delivery and/or opening of the ERM by an intended recipient.

Reference is made herein to ERM. As disclosed herein, ERM may include any digitized or electronic version of registered or certified mail. ERM may comprise any electronic communication in which at least some content is protected or unavailable until a recipient has verified their identity. ERM may be provided through an email, a text message, a short message service message, a push notification, an application message, or any other electronic communication method.

As discussed herein, a sender includes an entity that needs to provide ERM or other certified mail to a recipient. A sender can include a business or financial institution, a law firm, a government organization, a service provider (e.g., a self-storage organization), a lien holder, etc. The sender provides content for the example ERM disclosed herein in addition to recipient information, such as a recipient name and/or aliases of the recipient, recipient physical address, and/or a recipient electronic address (e.g., an SMS identifier, email address, etc.). The sender may also specify one or more verification options for the ERM.

In some instances, the ERM may be provided in multiple stages. Initially, a pre-notification message is provided by a sender to a recipient. The pre-notification message is indicative that a message with verification instructions will be transmitted. In a second stage, a notification message with verification instructions is provided to the recipient. Then, in a third stage, a content message is provided by the sender to the recipient. The content message provides access to the personal and/or sensitive information after the recipient has been verified through the message with verification instructions. It should be appreciated that in some embodiments, the ERM may include only two stages: a notification message with verification instructions and a separate content message that provides access to the personal and/or sensitive information. In yet another embodiment, the ERM may include a single message with verification instructions that unlocks access to the personal and/or sensitive information after verification.

In some embodiments, the ERM may include links to web-based resources. For example, an ERM (e.g., a notification message and/or ERM protected content) may include a link to a web form to enable a recipient to enter information. In another example, an ERM may include a link to a payment processor to enable a payment to be made by a recipient. Additionally or alternatively, the ERM may include operations to enable a recipient to communicate with a sender using, for example, a SMS, email message, video call, or audio call. In these embodiments, the ERM may include embedded operations to launch a connectivity application and begin a secure communication session with a sender.

The disclosure below refers to verification. As described herein, verification includes a procedure in which a user provides sufficient information or evidence to demonstrate they are the indented recipient of a sender. The example method, system, and apparatus may provide a recipient options for verification, including live verification, near real time verification, and/or automated verification. The verification may include comparing facial images to an image on an approved ID card, facial images to a database of approved images, voice information to a voice signature, movement/voice information to a movement/voice prompt, and/or name/address information on an ID card or entered by the recipient to a name/address on record. In some instances, verification may include use of a recorded image or audio of a barcode/watermark to provide an indication that the verification information provided by the recipient is live/current and not from a recording or comprises computer manipulated information, such as deep fake content.

The present disclosure refers to user devices. As disclosed herein, a user device may include any smartphone, cell phone, PDA, tablet computer, smartwatch, smarteyewear, virtual keyboard, laptop computer, workstation, etc. The user device includes at least one of a web browser for accessing websites or databases for verification or fulfillment of an ERM, an application for displaying contents of an ERM, and/or a camera/microphone for recording images/audio related for verification. The user device also includes at least one of an email application, an SMS application, and/or web browser configured to enable a user to receive notifications of an ERM, complete verification for an ERM, receive contents of an ERM, and/or communicate with a sender.

### Example ERM System

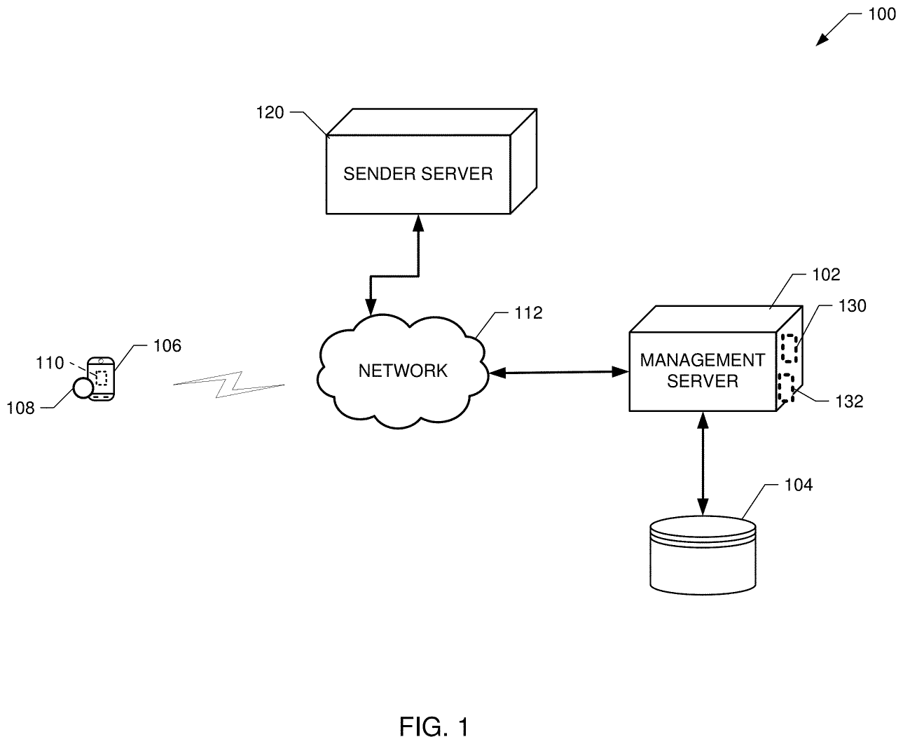

FIG. 1 shows an example ERM system 100 for ERM management, according to an example embodiment of the present disclosure. The example system 100 includes a management server 102 configured to create ERM, provide verification of ERM, and provide fulfillment of ERM. In some embodiments, templates for ERM, content for ERM, and/or verification information is stored in a memory device or database 104.

The example system 100 also includes one or more user devices 106 that enable a user (e.g., a recipient) to view ERM and related content, and provide verification information. The example user devices 106 include one or more web browsers, email programs, SMS applications, or other web-based applications (shown as user interface 108) for displaying contents related to received ERM. The user device 106 may additionally or alternatively include a camera, microphone, keyboard, etc. that enables a user to provide verification for ERM. The example user device 106 may further include a browser plug-in or application 110 for enabling a user to provide verification (and/or view content) for an ERM.

The example user devices 106 are communicatively coupled to the management server 102 via a network 112. The network 112 may include any wireless or wired network including, for example, the Internet, a cellular 4G, 5G, or 6G network, a Wi-Fi network, a local area network, or combinations thereof. While FIG. 1 shows the user device wirelessly connected to the network 112, in other embodiments the user device 106 may be connected via a hardwire, such as an Ethernet connection.

The ERM system 100 of FIG. 1 also includes a sender server 120 for initiating ERM. The example sender server 120 is configured to provide operations related to a business, legal, or government function of the sender and enable a sender to provide information for creating ERM. In an example, the sender server 120 may include a self-storage management server that maintains self-storage accounts of customers. The sender server 120 may track and determine which accounts are delinquent. As such, the sender server 120 may interface with one or more application programming interfaces (“APIs”) at the management server 102 for creating ERM and other lien notifications to address the delinquent accounts.

In some examples, the sender server 120 may include a computer, tablet computer, smartphone, etc. that has a web browser or other interface for creating ERM. In some embodiments, the sender server 120 is configured to display a web-based form or an interface to the management server 102 to create an ERM. This may include displaying prompts for a recipient name, email address (or other electronic address), physical device, and content to be conveyed. The content may be provided by the sender server 120 or a third-party database specified by a sender. The content may be physically attached to the ERM and/or the ERM may include a hyperlink to an electronic location of the content. In some instances, the content may include alpha-numeric text to be read by the recipient. The content may also include one or more action buttons to prompt and record a response by the recipient, which is transmitted back to the sender server 120 and/or the management server 102. In this scenario, the management server 102 may provide a response received from the user device 106 and/or verification for ERM that was created by the sender server 120.

In some embodiments, the sender server 120 is configured to connect to the management server 102 to create ERM. The management server 102 may host a website or one or more APIs that enables the sender server 120 to provide information for the ERM, including address, name, and content. The content may be stored to the database 104 as part of attaching the content to the ERM or including a link to the content in the ERM. Alternatively, the content may be located at a third-party database and linked to the ERM. The sender server 120 provides the information for the management server 102 to create and send the ERM (including the notification message and/or ERM protected content). In this embodiment, the management server 102 provides verification in addition to the creation of the ERM.

In the illustrated embodiment, the management server 102 includes one or more routines, algorithms, and/or machine-readable instructions that specify operations to be performed by one or more processors for creation and/or verification of ERM. The instructions may be stored, for example, within the database 104 or another memory device for a processor of the server 102. The instructions may specify how a name manager 130 and/or verification manager 132 are to operate. The verification manager 132 may include one or more APIs to enable the sender server 120 to create ERM, including prompts for a name field, an email address field, and a content field. A copy of created ERM (including a notification message and/or ERM content) may be stored to the database 104. In some embodiments, the database 104 may store a data structure (or indication in a table) with each ERM to indicate whether the ERM was delivered, opened, read, verified, etc. The indication may include a timestamp as to when a message was received from the user device 106 that is indicative of a date/time of the action related to the ERM. The database 104 may also store in relation to an ERM, verification information provided by the recipient.

In instances where content is provided in a separate message, the management server 102 may include one or more APIs to facilitate the creation and/or reception of content. The management server 102 stores the content in the database in relation to the corresponding ERM. After verification is received (in the sender server 120 or the management server 102), the management server 102 transmits a message with the related content.

The verification manager 132 may also include one or more APIs that are called via messages by ERM when accessed by a recipient. The message calls may provide an indication that the ERM was electronically delivered to the user device 106 or an account accessibly the user device, an indication that the ERM was opened at the user device 106, and/or an indication that the ERM was read by a recipient using the user device 106. The APIs may also provide for verification of a recipient, including interfaces for receiving recorded images/video or information input by the recipient into the user device 106.

In an embodiment, the management server 102 (via the verification manager 132) is configured to enable the creation of ERM with a feature that enables a recipient to request a name and/or address update, or request the ERM be directed to a substitute recipient. The management server 102 may structure the ERM such that the identification (“ID”) information is collected with the request for the name/address update or substitute recipient. As such, the management server 102 may provide verification of the substitute recipient and then request the sender server 120 to accept or decline the change to the substitute recipient. The example management server 102 (via the name manager 130) is configured to transmit a message to the sender server 120 asking to confirm (or provide an alternative name/address). The management server 102 (via the name manager 130) may also provide at least some of the ID information, including, for example, an image of the recipient's ID card to provide context associated with the request and/or to enable the sender to verify the recipient is indeed correct or approve the substitute recipient. If the sender server 120 confirms the name/address adjustment, the management server 102 (via the name manager 130) validates the recipient using the updated name/address. This may include updating a copy of the ERM, stored in the database 104, with the updated name/address. After acceptance of the substitute recipient by the sender server 120, the management server 102 does not have to re-verify a substitute recipient because the verification information was already collected and verified. If the sender server 120 provides a different or amended name, the management server 102 (via the name manager 130) updates the ERM with the different or amended name and continues the validation procedure with the same or a substitute recipient.

The example management server 102 (via the name manager 130) also includes one or more algorithms for verification. For example, the name manager 130 may use one or more routines for determining if a name provided by a recipient (or included in an ID card) through a verification process for the ERM matches a name entered by a sender (stored in the database 104). The name manager 130 may use one or more threshold values and/or weights for matching. For example, the name manager 130 may use a single value, which may be static or specified by the sender server 120 (e.g., rigid, medium, loose). The name manager 130 may use different thresholds for first, middle, and last names, and/or addresses. Moreover, the name manager 130 may group certain characters together such that receipt of one character in the group constitutes a match. In yet other embodiments, the name manager 130 may remove certain special characters, such as accents, comas, apostrophes prior to making a comparison.

In some embodiments, the name manager 130 may adjust a threshold or provide a weighting per character based on individual characters or certain groups of characters. For instance, the name manager 130 may apply a first weight to standard alpha-numeric characters while applying a second lower matching weight to special characters or characters. The example name manager 130 may also adjust thresholds and/or weights based on language and/or a culture of the sender/recipient and/or a compatibility rating between a language/culture of the sender/recipient.

In an example, the name manager 130 may determine that a sender is of the same language/culture as a recipient based on an address of the sender and an address of the recipient. As such, the name manager 130 may apply a lower weighting threshold when comparing a name and/or address of a recipient specified in ERM to a name and/or address provided by the recipient. In another example, the name manager 130 may determine that a sender is of a different language/culture of a recipient. The name manager 130 may accordingly apply a higher weighting threshold when comparing a name and/or address of a recipient specified in ERM to a name and/or address provided by the recipient.

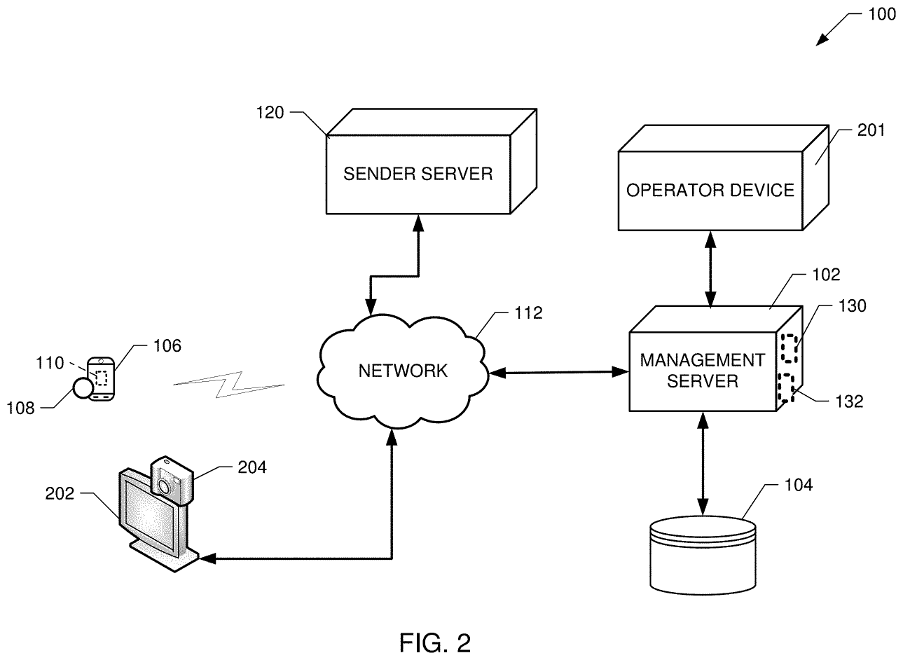

FIG. 2 shows a diagram of the ERM system 100 of FIG. 1 illustrating an embodiment for recipient verification. The management server 102 may be configured to provide for different options for recipient verification. In some instances, the sender server 120 may specify a verification option at the creation of ERM. In other instances, the verification manager 132 provides an option, via the ERM, to a recipient for verification. Some recipients may desire to opt-out of automated checks of their personal information and rather have a human operator verify their information.

It should be appreciated that in some embodiments, the management server 102 is configured to bypass verification for recipients that have already registered and/or been previously verified. For instance, a recipient may be registered after receiving a first ERM. The registration may include creating and/or otherwise storing a verified ID, credentials, and/or an electronic ID (“eID”) of the recipient to the database 104. Then, for subsequent ERM, the management server 102 may use the verified ID in the database 104 to confirm the recipient is verified before providing content of the ERM.

In an embodiment, the management server 102 (via the verification manager 132) is configured to provide for live verification when an operator is in communication contact with a recipient. The management server 102 makes this option available through the ERM. In this example, the recipient uses device 106 to access the ERM and select an option for a live session. A request message is transmitted from the user device 106 to the management server 102. After receiving the message (via the verification manager 132), the management server 102 selects an operator at an operator device 201 for a live session or places the user into a queue. During the session, an operator, using the operator device 201, provides a series of questions to enable the recipient to provide verification, including name, address, etc. The operator may also compare an image of the recipient (during a video session) to a picture on an ID card or a picture stored in the database 104. In some instances, the management server 120 is configured to receive from the recipient a copy of their ID card, which is provided in sufficient quality to enable security points to be checked.

If verification is performed, the operator selects an input which causes the server 102 (via the verification manager 132) to verify the ERM and provide access to its related content. In some embodiments, after verification, the server 102 (via the verification manager 132) may generate and provide to the user a code (e.g., a QR code) or a pin code, which the user can provide to by-pass the live check for subsequent ERM. The management server 102 (via the verification manager 132) may correlate or associate the code to the recipient's email address or other electronic address stored in the database 104. It should be appreciated that the live option is not preferable given the high cost of labor for the operators and the slow verification time as a result of the verification conversation.

In a near real-time option, the example management server 102 (via the verification manager 132) provides instructions to a recipient (via the ERM) regarding what information is needed for verification. In some instances, the instructions may be included with the ERM and displayed after the recipient selects the option. The instructions may prompt a recipient to send an electronic copy of an ID card, record a video of themselves, including the ID card, and/or identify what information is needed for the video. The information may include certain angles of a recipient's face, a voice recording, showing an ID card next to a user's face, scanning or recording an image of an ID card, attaching a copy of an electronic ID card, etc. The recipient uses either the device 106 and/or a computer 202/camera 204 to provide the additional information to the management server 102 for verification.

In this near-real time embodiment, the management server 102 (via the verification manager 132) receives the video, images, and other verification provided by the recipient using devices 106 and/or 202. The management server 102 (via the verification manager 132) queues the information for review by an operator at the operator device 201. After the operator provides a positive indication, the management server 102 provides verification of the ERM and provides access to the content. The verification manager 132 may also store a record of the positive indication in relation to the ERM in the database 104. If a negative response is received, the management server 102 may convey a message from the operator to the recipient regarding what additional information is needed.

The example management server 102 (via the verification manager 132) may also be configured to use one or more algorithms and/or routines to perform auto-verification. For this option, the ERM, and/or a message from the management server 102 (via the verification manager 132) may prompt a recipient for certain information and/or record video/audio. The management server 102 (via the verification manager 132) uses the one or more algorithms to process the received information to verify the recipient is the intended recipient of the sender.

In an example, ERM provided by the management server 102 to the user device 106 may include instructions for a recipient to provide a copy of an ID card, such as by recording a high resolution photo or scanning a document. The ERM and/or management server 102 may also prompt the recipient to record a video of themselves, including them holding up the ID card. Further, while the video is recording, the ERM (or the application 110) may instruct the recipient to write a code or message, say a phrase, or move in a certain direction. The instructions may be specified or encoded in the ERM itself. Alternatively, the instructions may be transmitted from the management server 102 to the application 110 (or transmitted in a separate message/email) upon receiving an indication that the ERM was opened.

To perform verification, the example management server 102 (via the verification manager 132) may perform an OCR on a copy of the recipient's ID card to extract the relevant text and compare the extracted information to information provided by the sender. The management server 102 may use an image template and/or one or more face matching routines to verify the scanned ID card matches the card held by the recipient and/or confirm an ID picture matches the face of the recipient. The server 102 (via the verification manager 132) also confirms the recipient performed the specified action using, for example, audio processing of the voice data or motion vectors to determine face or other bodily movement. The server 102 (via the verification manager 132) may analyze one video frame or a series of video frames as part of the verification process. In some instances, the server 102 (via the verification manager 132) may transmit one or more messages to the recipient indicative of additional information needed to perform a verification, such as facial movements or holding the ID card closer to a camera. After providing verification, the management server 102 (via the verification manager 132) provides any related ERM content to the recipient.

FIG. 2 shows that a recipient may provide verification using two different devices. To associate the devices with the same session, the recipient may open an email with the ERM on the user device 106 and the device 202. In addition, the recipient may select an option for verification when both devices are used. For example, on the device 202, the recipient may indicate the device will record video. The management server 102 (via the verification manager 132) records responses from both devices 106 and 202, including electronic network or hardware (e.g., MAC) addresses and associates the information with the same session. The recipient may then use camera 204, coupled to the device 202, to record video or other information, which is transmitted to the management server 102 for verification.

In another example, the recipient may open ERM with the first device 106. The ERM may include a website address and/or code. The recipient enters the website address and/or code into the second device 202, which causes a session request message to be transmitted to the management server 102. In response, the management server 102 (via the verification manager 132) relates both devices 106 and 202 to the same session for providing verification.

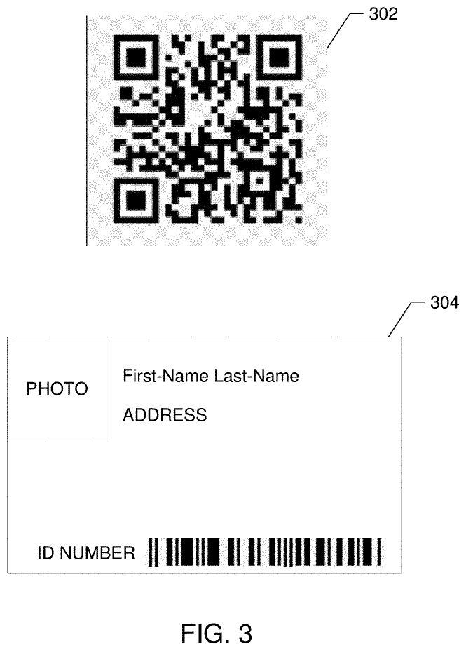

FIG. 3 shows a diagram of information that may be provided by a recipient for verification. The information includes an ID card 304. A recipient may use either of the devices 106 and 202 to record a high quality image of the ID card 304. In addition, the recipient may be prompted by the server 102 to hold the ID card 304 next to their face during the verification process. During the process, the ERM (or an application 110 on the user device 106) may cause a camera application on the user device 106 to open to enable video and/or images to be recorded. The ERM and/or application 110 may then open a communication connection to an API at the management server 102 for transmitting a recorded image of the ID card 304. The example server 102 is configured to use one or more OCR algorithms to extract text on the ID card 304 for comparison to information provided by the sender. The server 102 may also use an output from a barcode reader on the user device 106 (or barcode reading algorithm that reads the barcode in an image) to confirm that the scanned barcode from the ID card 304 matches the generated ID number. The server 102 may further use one or more image matching template algorithms to compare the received photo of the ID card 304 to recorded images of the recipient. After a recipient has been verified, the management server 102 may store a copy of the recipient's information, including an eID to the database 104 so that the recipient does not have to re-register for subsequent ERM. In some embodiments, the server 102 (or an application 110 on the user device 106) may cause a three-dimensional scanner, a fingerprint reader, and/or a near-field communication (“NFC”) reader to obtain an image/information from the ID card 304 and/or the recipient. In these embodiments, the read and/or scanned image/code may be stored in the database 104 for re-verification of the recipient for other ERM.

The information of FIG. 3 also includes a QR code 302, which may also include a bar code or any alpha-numeric code. In some embodiments, the server 102 (via the verification manager 132) is configured to generate a unique code, which may be displayed via alpha-numeric characters, within a barcode, or a QR code after an ERM is opened. The server 102 causes the code 302 to be displayed, for example, on the device 106 within ERM. The server 102 then instructs the ERM recipient to use the camera 204 to record an image of themselves and/or the ID card 304 next to the code 302 displayed on the device 106. The user device 106, via the ERM and/or the application 110 transmits the recorded image of the QR code 302 to an appropriate API at the management server 102. The server 102 then compares the values of the images code 302 to the values generated for the code (stored in the database 104 in relation to a copy of the ERM) to confirm the recipient is live and present for the verification.

In some embodiments, a recipient may be registered with the management server 102 before an ERM is created. The management server 102 may register a recipient by receiving one or more images of the recipient, one or more images of an identification of the recipient, and/or storing other identifying information such as a unique code in relation to recipient information. In some instances, registration may be provided in conjunction with the operator device 201 and/or a notary, a private agent holding credentials to provide online identification, or other sworn agent whose word and identity verification holds legal value. Upon verification, the operator device 201, notary, or other agent may provide the recipient with a unique code to provide the management server 102 to confirm verification of their identity. For registered recipients, the management server 102 may provide a prompt or field with the ERM for entering the recipient's unique code, credentials, eID, or recording an image of themselves and/or their identification card. For a unique code, the management server 102 compares the received code to a stored code to determine a match for verification of the recipient. For an image of an identification card, the management server 102 extracts text from the image using an OCR algorithm and compares the extracted text to the registered identification card text for verification of the recipient. For an image of the recipient, the management server 102 uses a face matching algorithm to the stored registered image of the recipient for verification of the recipient.

### Example Process for ERM Verification

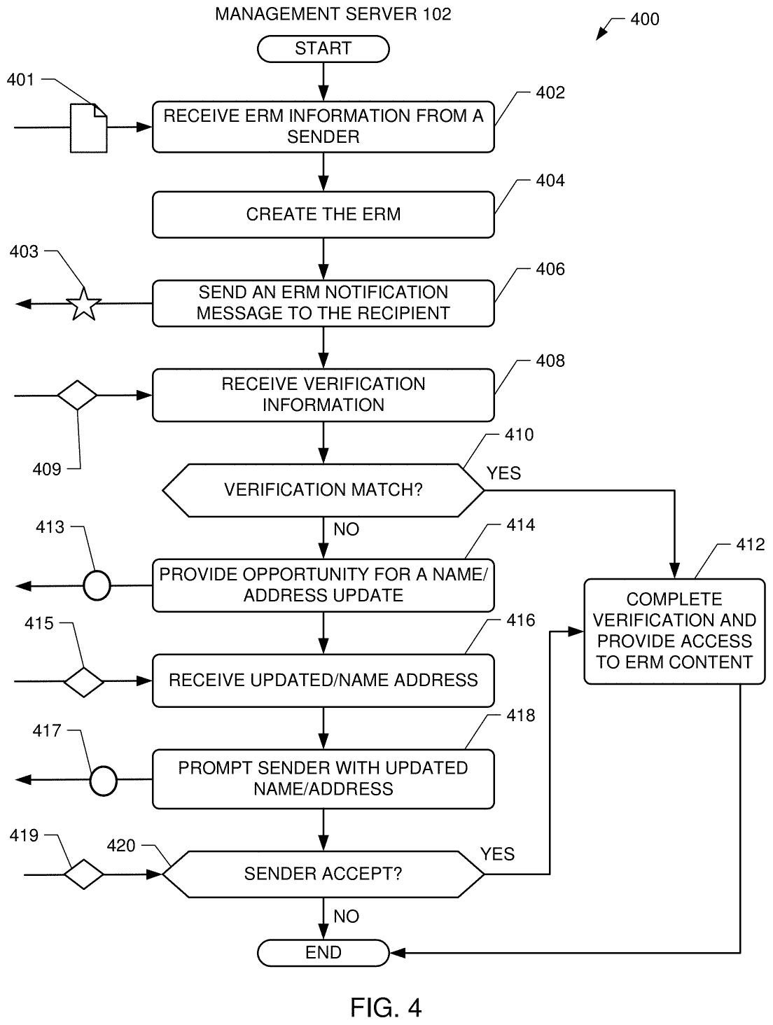

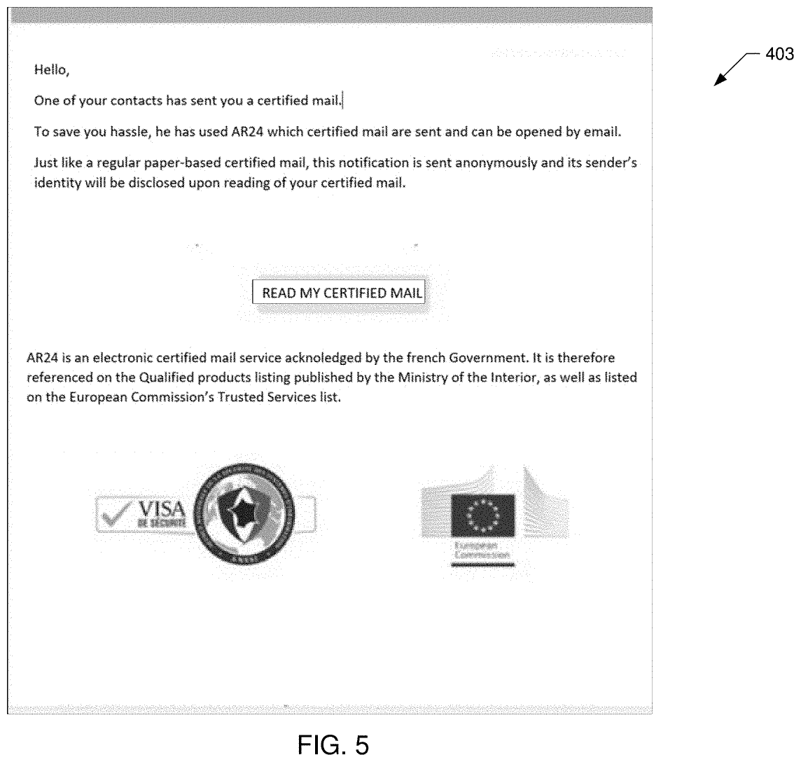

FIG. 4 shows a diagram of an example procedure 400 for providing ERM verification, according to an example embodiment of the present disclosure. In the illustrated example, the sender server 120 provides information 401 for creation and/or inclusion in an ERM (block 402). The example management server 102 uses the information 401 to create an ERM notification message 403 (block 404). The management server 102 then sends the ERM notification message 403 to an email account, application account, or SMS account related to the recipient using an electronic address provided by the sender server 120 (block 406). It should be appreciated that the ERM notification message 403 may include an email or other message that provides a notification to the recipient regarding the availability of contents of the ERM. The recipient is not able to view the ERM contents until verification has been completed. FIG. 5 shows a diagram of an example ERM notification message 403, which includes notification text with links to begin verification for receiving the contents of the ERM notification message 403. The transmission may include an email message, a text message, etc.

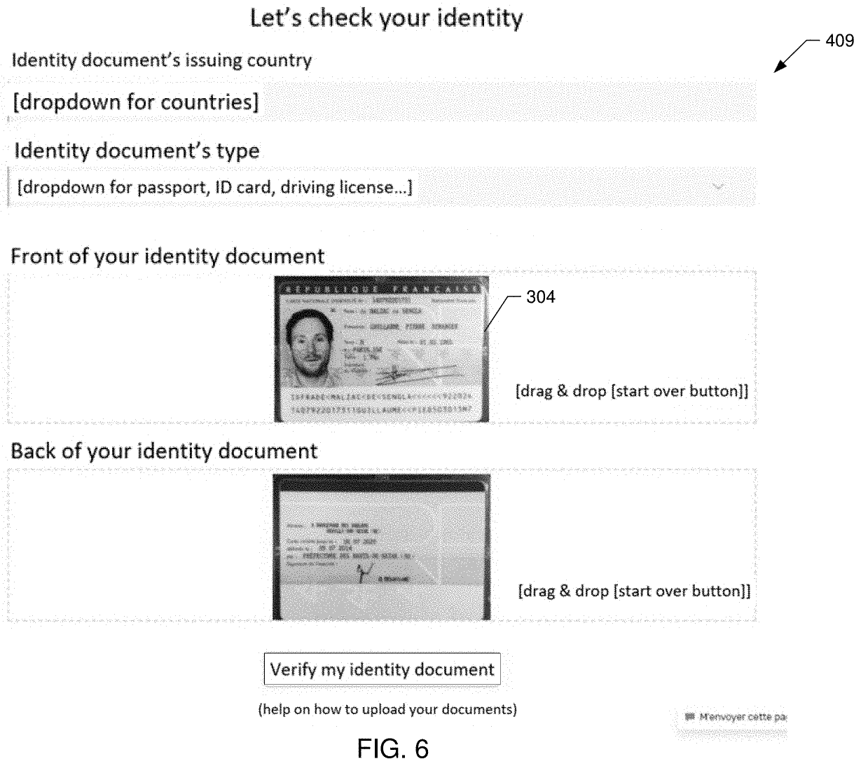

Some time later, the server 102 receives verification information 409 from a user device 106 of the recipient from which the ERM notification message 403 was accessed (block 408). FIG. 6 shows an example of verification information 409 provided by a recipient via the user device 106, including an image of an ID card 304. As shown, the verification information 409 corresponds to fields specified by one or more APIs that are connected to the ERM notification message 403 or an application 110 operating in relation to the ERM notification message 403.

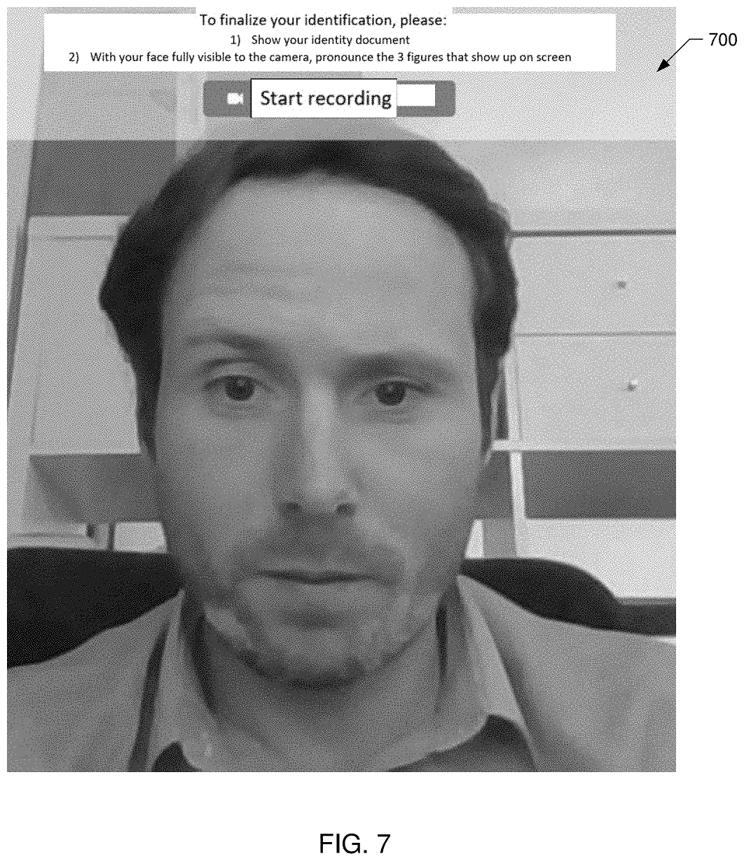

FIG. 7 shows an example of a video recorded of a recipient, using user device 106 and/or device 204, for providing visual verification information. During the video, the server 102 may instruct the recipient to move a certain direction, display an ID card, and/or display a code sent to their device 106 via email or text message. As discussed above, the verification information 409 may include information entered by the recipient, a scanned ID card, video of the recipient, video of an ID card with the recipient, video of a code, etc. The server 102 then determines if the verification information 409 received matches the information 401 provided by the sender. The example server 102 may use one or more algorithms for matching the information 401 and 409 (and/or information stored in the database 104 in relation to a copy of the ERM).

In an example, there may be a plurality of different types of information 401 that is provided by the sender which is analyzed by the server 102 to determine a match. The different types of information 401 can include, for example, to_name, to_title, to_prefix, to_birthdate, to_gender, to_nationality, to_firstname, to_lastname, to_companyname, and/or to_ physicaladdress. To analyze a match, the server 102 identifies a name, including first name and last name on the ID card. The server 102 may also identify an address on the ID card. In some examples, the server 102 removes special characters, such as accents, comas, apostrophes, hyphens, etc. and replaces accented characters by their non-accented version.

After the characters are processed, the server 102 determines what information was provided by the sender, such as first and last name, single name, etc. and compares the names provided by the recipient. If a sender provides a first and last name, the server 102 determines if the recipient has provided a matching first and last name. If not, the server 102 determines a match does not exist. If there is an exact match between the characters, the system determines there is a match. If there is less than an exact match, the example server 102 calculates a similarity score between the names (and/or addresses) and determines a match if a threshold (e.g., 90%) is exceeded. In some embodiments, the server 102 may implement a programming classics method for comparing characters, a Levenshtein method (that determines a minimal number of characters needed to be replaced to create a match), an inclusion method (searching for name prefixes such as Mr. or Dr.), an inversion of words method, and/or an inversion of fields method, or combinations thereof to determine a degree of similarity between the names. The example server 102 may also isolate first names based on a presence of a coma to accommodate situations where a recipient may have multiple first names. The example server 102 may additionally concatenate the first names together to form a single word for comparison and analysis. In other examples, the server 102 may apply matching weights based on character type, a location of a sender, a location of a recipient, and/or a linguistic compatibility between the sender location and the recipient location.

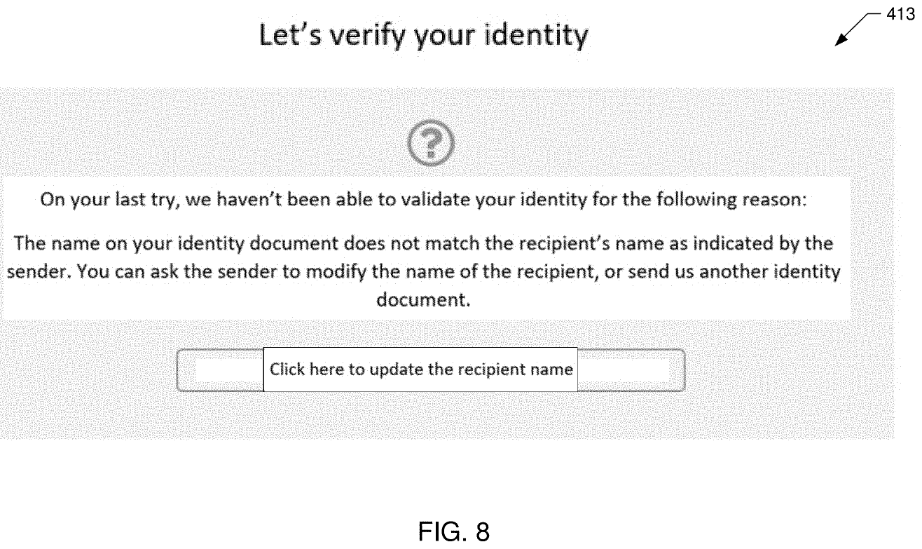

If there is a match, the example server 102, the procedure 400 completes the verification and provides access to ERM content that is related to the ERM notification message 403 (e.g., the notification of the ERM) (block 412). This may include sending a separate message to the user device 106 and/or causing the ERM notification message 403 to unlock local content (such as a section of an email message or make an attachment available or unlocked). If there is not a match, or substantial similarly between the names and/or addresses provided by the sender and the recipient, the example server 102 transmits a message 413 that provides an opportunity for the recipient to update the name and/or use the name provided on their ID card that generated the mismatch (block 414). FIG. 8 show a diagram of contents of the message 413 to indicate that there is a mismatch in information provided.

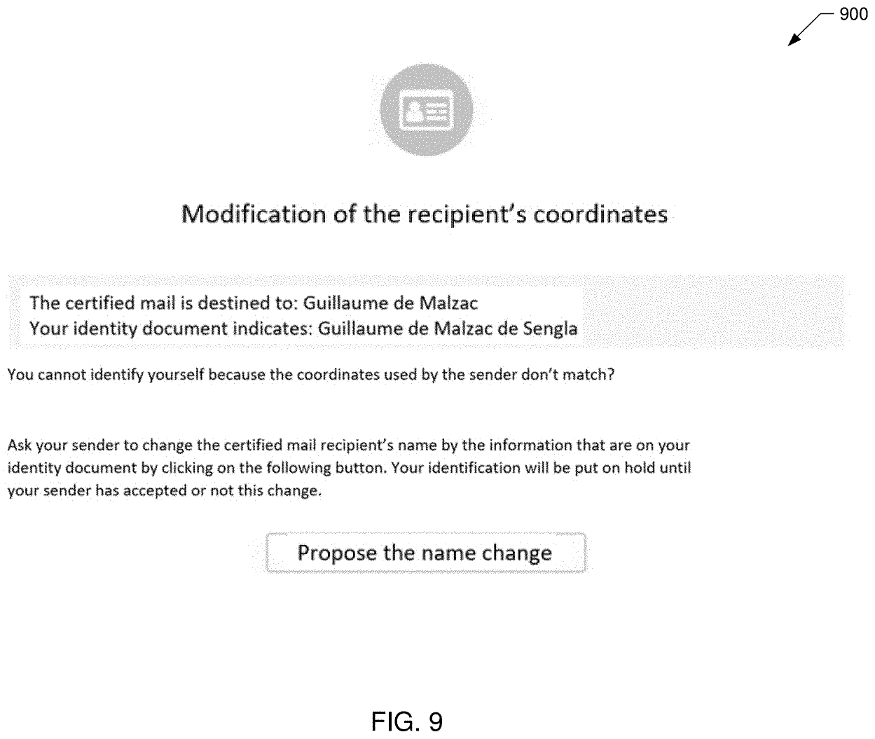

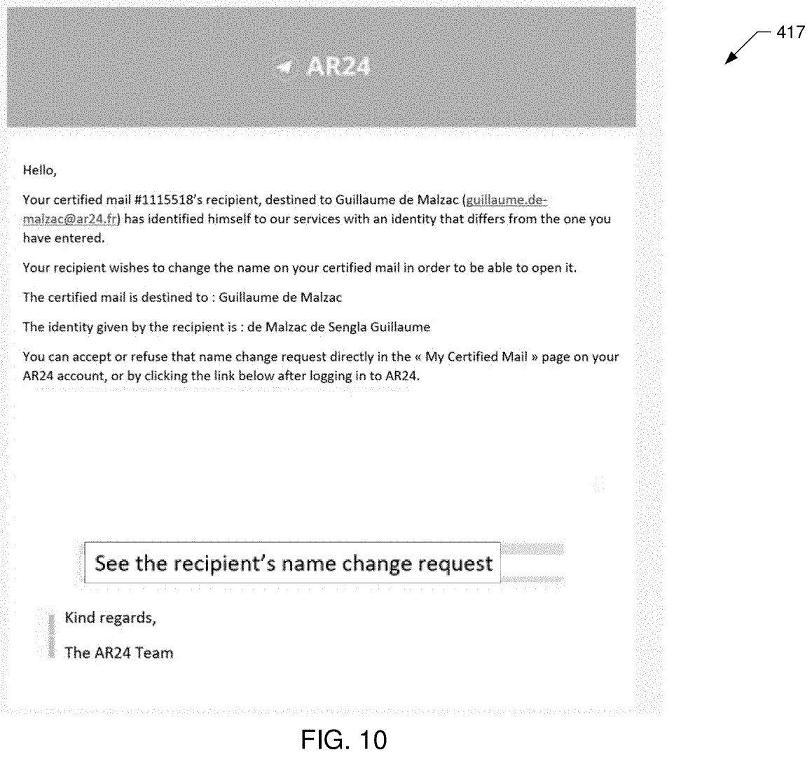

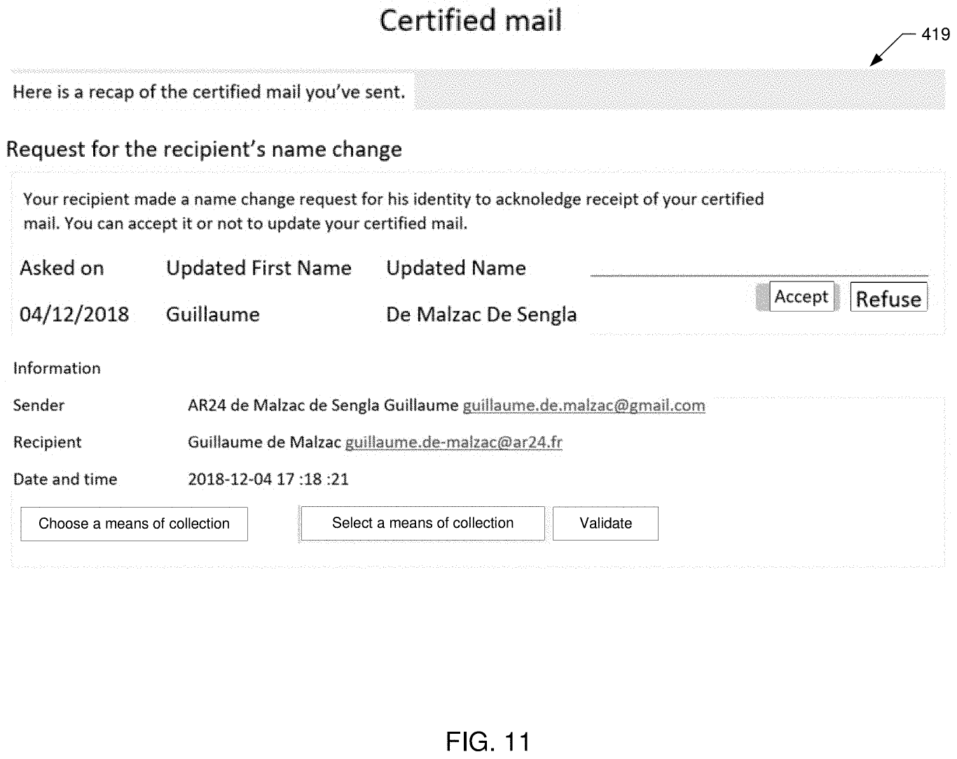

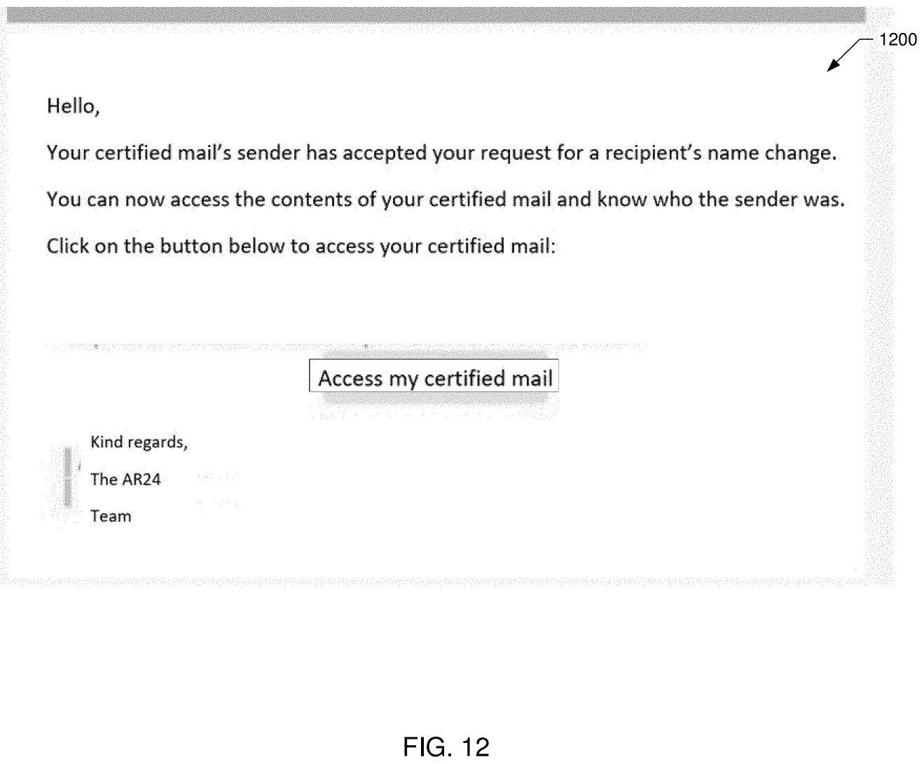

The example server 102 in the illustrated embodiment receives a response message 415 from the user device 106 of recipient that includes an updated name/address and/or confirmation to use the name on the ID card (e.g., a name change request) (block 416). FIG. 9 shows a diagram of a user interface 900 for enabling a recipient to update their name/address and/or confirm to use a name/address provided on their ID card, such as a substitute recipient. The example server 102 then transmits a message 417 and/or a prompt (e.g., an email) to the sender server 120 inquiring if the updated name and/or address of the recipient (or substitute recipient) is acceptable (block 418). FIG. 10 shows an example diagram of the contents of the message 417 provided to the sender requesting acceptance of an updated name/address. The server 102 next receives a response message 419 from the sender server 120 indicative of acceptance (block 420). FIG. 11 shows an example diagram of a user interface provided the server 102 to the sender server 120 that enables the sender to accept the updated name/address. If the sender accepts, the example server 102 receives an acceptance message from the sender server 120, completes the verification, and provides access to content of the ERM (block 412). In addition, the server 102 may transmit a message, as shown in FIG. 12, with contents 1200 indicative of the acceptance of the name change. The server 102 may also update the name/address of the recipient in the ERM and a copy of the ERM (including the notification message) in the database 104. However, if the sender does not accept, the example procedure 400 ends. In some alternative embodiments, the server 102 may be configured to provide the recipient another opportunity for verification using another document and/or verification procedure.

While the example procedure 400 shows the name/address update procedure occurring after verification failed, it should be appreciated that the update may occur before then, such as after the recipient views the notification regarding the ERM. For example, a recipient may view the ERM and know that the name is not correct or their documentation shows a different name. It should also be appreciated that the name change does not require the same recipient. For example, a recipient may request that the name be changed to a different substitute person, if for example, the original recipient is not available.

### Additional Embodiments

In addition to above, the example server 102 may be configured to perform any of the following features individually or in combination. In some embodiments, the server 102 may provide a unified ERM reception system. Oftentimes, known Qualified electronic Registered Delivery Services have different verification requirements. The example server 102 may enable different ERM providers to send ERM but provide a single verification for the information received.

In some embodiments, the server 102 may enable a sender to send an ERM in the name of someone else or a company name. Further, the server 102 may send a warm-up email along (or just before) an ERM notification, with the sender's name, alias and graphic identity (with his approval) to warm-up the recipient and let them know why they are being notified regarding the ERM, and that this is not a phishing attempt. The server 102 may also send a ‘clear’ email with the ERM's contents along (but after or in parallel to) the notification. Some recipients ignore ERM notifications and do not provide verification. In some instances, a sender may request that the server 102 provide ERM contents (or a summary of the contents) in a simple email with clear information to stress the urgency of the matter.

In some embodiments, the server 102 may use a regex and logic to make sure a recipient's email address is valid (e.g., presence of an @ and an extension). The server 102 may also use a regex and a database to check if an email address has already been used successfully or not and avoid re-notifying an email address that is no longer in use or associated with a recipient. The server 102 may further use a regex and a database of first names and last names to help with name typing to avoid potential typos. Moreover, the server 102 may use a regex and a database on email extensions (“@xxxxxxx.xxx”) to inform a recipient typing an email address that there is already is an official email address for notifications towards a company. Additionally or alternatively, the server 102 may operate with a virtual printer to send an ERM and/or operate with a scanner/copies to receive and send certified mail electronically.

### Lien Notification Embodiment

The example management system 102 of FIGS. 1 and 2, in some embodiments, may be configured to provide lien notifications. As described herein, a lien notification is a document provided by an account provider that an account of a recipient is overdue for payment. The account provider may include a financial institution, a self-storage facility, a service provider, a retailer, etc. Many U.S. states and foreign jurisdictions have rules that specify the manner in which a lien notification is provided to a recipient. Oftentimes, the rules specify that some form of documentation must be created that provides sufficient evidence that the recipient was placed on notice regarding a pending lien. If the recipient does not pay the outstanding balance within some time period after receiving the lien notification, the account provider can begin a collection process. For a self-storage facility, this includes a storage auction, made popular by a realty television show in the U.S.

In some instances, an account provider can be liable for damages if a recipient can show they were never actually notified of a delinquent account and given an opportunity to rectify. The litigation and damages can be costly to the account provider and deter account collections. The litigation and damages can also cause bad publicity or reputation for the account provider.

The example management system 102 described herein is configured to provide an automated or near-automated process for account providers regarding a lien notification procedure. The management system 102 is provided with or programmed with rules for different justifications. The management system 102 is configured or coded to incorporate the different rules such that the lien notification process is specially tailored for each jurisdiction to conform to the related rules. As such, the management system 102 may not be able to perform certain operations if coding for a particular jurisdiction prevent or do not allow the certain operations to be performed.

As discussed herein, the management system 102 is configured to use ERM as part of the lien notification process. The use of ERM provides documented evidence as to whether a recipient was placed on notice regarding an overdue or past due account balance. The use of ERM also provides verification that the recipient is indeed the individual with the overdue account balance, providing further evidence that the lien notification was properly served.

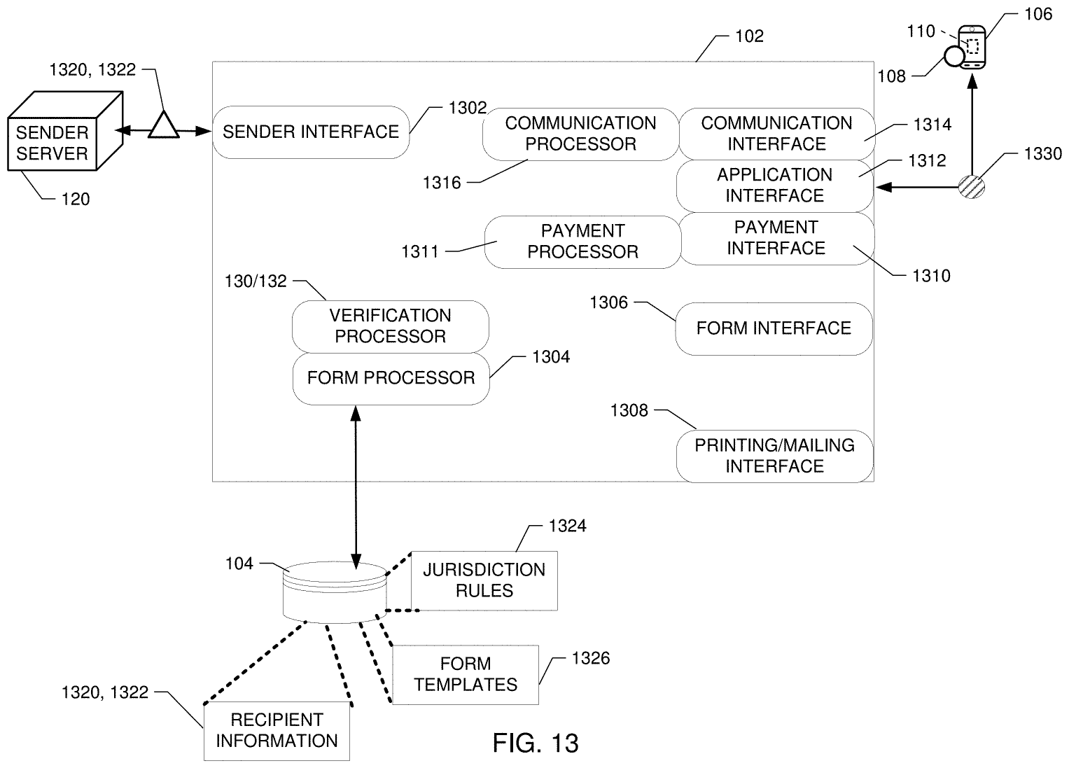

FIG. 13 shows a diagram of the management server 102 configured to provide lien notifications, according to an example embodiment of the present disclosure. The management server 102 includes components 130, 132, and 1302 to 1316. It should be appreciated that the components 130, 132, and 1302 to 1316 may be implemented by hardware, software, or a combination of software and hardware. In some instances, the components 130, 132, and 1302 to 1316 may be defined by one or more instructions stored in a memory device, such as the memory device 104. Execution of the instructions by a processor of the management server 102 causes the management server 102 to perform the operations described herein.

The management server 102 includes a sender interface 1302 configured to interact with the sender server 120. The sender interface 1302 may include one or more APIs that prompt or enable the sender server 120 to provide recipient information 1320 and content 1322 for creating a lien notification and/or ERM. The recipient information 1320 may include a recipient name, a recipient physical address, a recipient electronic address, and/or a verification option. The content 1322 may include a message or information, a hyperlink to the sender server 120 or a third-party server, a video, an image, etc. The content 1322 may also include account information, a copy of a rental agreement/contract, and/or lien information, such as an amount of an overdue balance, a state or country associated with the overdue balance, a recipient name of the account, an amount owed, and/or a due date for the amount owed. In some instances, the content 1322 may be provided in the form of a spreadsheet or account tracking software at the sender server 120. In these instances, the sender server 120 connects to one or more APIs at the sender interface 1302 for providing the content 1322. After receiving the recipient information 1320 and/or the content 1322, the sender interface 1302 stores the recipient information 1320 and/or the content 1322 to the memory device 104.

A form processor 1304 is configured to generate lien notifications and/or ERM based on the received recipient information 1320 and/or the content 1322. Generally, the content 1322 is only provided by the sender server 120 for overdue balances. The form processor 1304 identifies the applicable state and/or country from a coding of jurisdiction rules 1324 that is stored in the database 104. The coding of the jurisdictional rules 1324 may specify time minimum and/or maximum time limits for sending lien notifications and lien sales letters, etc. The coding of the jurisdictional rules 1324 may also specify acceptable delivery options for ending lien notifications and lien sales letters, etc. and procedures in the event a recipient is non-responsive regarding follow up notifications.

In an example, the state of California has a rule for self-storage operators. The rule states that self-storage operators can terminate the use of a storage location of an occupant when rent remains unpaid for 14 days and a preliminary lien notice is provided. The rule specifies that the preliminary lien notice can be sent to the occupant via email, regular mail with e certificate of mailing, or certified mail. The rule further states that if the overdue balance has not been paid 14 days after the preliminary lien notice has been sent, the self-storage owner can send a lien to sale notice. The rule states that the lien to sale notice has to be provided via email, or certified mail. After the lien to sale notice has been provided, the self-storage owner can sell or otherwise auction the items in the self-storage unit.

Regarding email delivery, the California rules state that the rental agreement must have provided that lien notices may be sent to an occupant by email and there is a written signature on the rental agreement from the occupant that consents to receive lien notices by email. Regarding proof for email delivery, the California rules state that the email must be transmitted to an occupant through an application on a personal electronic device that is secured by a password, biometric identifier, or other technology, and there is evidence demonstrating that the occupant logged into the application and read and acknowledged the document. The acknowledgment can be provided by the occupant signing an electronic signature on the document, or the document is provided on a website that enables the occupant to log in and read and/or sign the document.

In the California rules example, the coding of the jurisdictional rules 1324 may specify the time periods before notices can be sent, the types of delivery methods, and the verification options for delivery of notices. The coding of the jurisdictional rules 1324 may also prompt the sender server 120 to provide evidence of a signed rental agreement and evidence regarding delivery provisions. The coding of the jurisdictional rules 1324 may further specify which form templates 1326 of the database 104 are to be used that conform to the applicable jurisdictional rules. The form templates 1326 may include certain fields/information required by jurisdictional rules. Further, the form templates 1326 may include different form types including forms for a lien notification, a lien sale notice, etc.

In the illustrated example, the form processor 1304 compares the account information of the recipients to the coding of the jurisdictional rules 1324 to determine if/when certain forms are to be generated. For example, the form processor 1304 may determine that an account is at least 14 days overdue and per state law, may generate a lien notice. The form processor 1304 may use a state specified in the recipient information 1320 to determine which rules and/or forms to use. If the form processor 1304 determines that a form is to be created based on, for example, an account being over 14 days delinquent, the form processor 1304 selects the form template of the appropriate type for the appropriate state. The form processor 1304 then populates the form with the recipient information, including account information.

In instances where ERM is provided to deliver a form, the form processor 1304 selects one or more verification options, as specified by the sender server 120 and/or the coding of the jurisdictional rules 1324. The ERM may provide the lien form as the content of the ERM such that the lien form is only provided after a recipient's identification has been verified. In an example, the form processor 1304 creates ERM for a recipient using the recipient information and/or account information. The ERM is formatted into an SMS message or email address, with a destination address specified by the recipient information. The lien notice is encoded as a locked attachment or content to the SMS message or email address. In some embodiments, the lien notice may include a hyperlink to a payment processor to enable a recipient to make a payment. Verification by the management server 102 causes the lien notice to be unlocked or otherwise made available. In other instances, the form processor 1304 may only provide the lien notice in a separate SMS message and/or email after verification of the recipient is determined.

The example management system 102 includes a form interface 1306 and a printing/mailing interface 1308 for providing lien-related notices to recipients. The form interface 1306 is configured to transmit one or more forms electronically to an account of a recipient. For an email-based ERM, the form interface 1306 transmits the emails to the specified email address. For an SMS-based ERM, the form interface 1306 transmits the message to the specified SMS account of the recipient. For lien notice forms without ERM, the form interface 1306 transmits the form to the appropriate account of the recipient. The form interface 1306 may link or otherwise be communicatively coupled to an email provider and/or SMS provider API for transmitting the ERM and/or other lien notices electronically.

The example printing/mailing interface 1308 is configured to generate paper forms and physical mailings. The printing/mailing interface 1308 receives content for the ERM and/or form from the form processor 1304. The printing/mailing interface 1308 converts the received information into a document and/or mailing envelop for printing. The printing/mailing interface 1308 may instruct a printer to print the specified document and/or envelop.

Both the printing/mailing interface 1308 and the form interface 1306 may transmit transmission information to the form processor 1304, which is stored in the database 104 in relation to a copy of the ERM and/or the recipient. Such information may provide evidence that the ERM and/or lien notice was at least sent to the recipient. For certified mail, the printing/mailing interface 1308 may provide a tracking number to the database 104.

The example management server 102 of FIG. 13 includes a payment interface 1310 and a payment processor 1311. In the illustrated example, the user device 106 uses user interface 108 and/or application 110 to access an electronic account and open an email and/or SMS message with the ERM and/or a form template. For ERMs, the user device 106 provides verification information 1330. After verification, the ERM enables the user device 106 to make a payment by, for example, selecting a payment hyperlink. For lien notices without ERM, the line notice may include a hyperlink for payment. Selection of the hyperlink by a recipient accesses the payment interface 1310, which may include one or more APIs. In other embodiments, the payment interface 1310 may be at a separate payment entity.

The ERM may, for instance, cause a web browser or the application 110 to access the payment interface 1310, which provides fields to enter payment information. The payment information may include credit card information, bank account information, crypto currency information, etc. After receiving a recipient's payment information, the payment interface 1310 transmits the payment information to the payment processor 1311. The example payment processor 1311 operates in conjunction with the appropriate financial service server to extract payment to the account provider. In addition, the payment processor 1311 transmits an update message to the database 104 indicative of account payment.

The example management server 102 includes the verification processor 130/132 (the name manager 130 and the verification manager 132 of FIGS. 1 and 2). The verification processor 130/132 operates in conjunction with an application interface 1312 for verifying an identity of a recipient of ERM and/or a lien notice. When a recipient opens ERM and selects a verification option, the ERM (and/or the application 110 on the user device 106) accesses the application interface 1312, which provides one or more fields for entering verification information 1330. The verification interface 1312 transmits the received verification information to the verification processor 130/132. As discussed above in connection with FIGS. 1 to 12, the verification processor 130/132 compares the verification information to recipient information and/or a code in the database 104. This includes name matching, address matching, facial recognition, etc.

In some embodiments, information regarding the recipient may be acquired by the sender server 120 during a registration for a storage unit. This may include a registered name, physical address, email address, and/or photo. The sender server 120 transmits at least some of this information as the recipient information 1320 for storage in the database 104. Later, the verification processor 130/132 accesses this information for verification of the recipient. This may include matching a facial image of the recipient to the recipient's photo recorded at the time when the storage unit was reserved. This may also include matching a photo of a recipient's identification card (such as a driver's license or passport) to the registered photo and using OCR to compare a recipients name and address on the identification card to a registered name and address using the name matching algorithms discussed above.

If the verification processor 130/132 is able to verify the recipient, the verification processor 130/132 transmits a verification message to the user device 106 and/or an email account of the recipient. The verification message may unlock content, such as generated lien notice that was provided with the ERM. Additionally or alternatively, the verification message may include the lien notice itself, which may be sent as an email message, a SMS message, or a message for display via the application 110.

The example management server 102 of FIG. 13 includes a communications interface 1314 and a communications processor 1316 to enable a recipient to communicate after receiving and opening ERM and/or a lien notification. The form processor 1304, in some embodiments, may embed an option for a recipient to initiate communication in ERM and/or a lien notice. Selection of the option causes the ERM and/or the application 110 on the user device 106 to open a communication medium with an electronic address related to the communication interface 1314. For an email, this would include opening an email program on the user device 106 and entering an email address of the communication interface 1314 into the email. For an SMS message, this would include opening a SMS application on the user device with a chat window for the application interface 1314. For a live-call or video call, this includes opening a video call or telephone call application on the user device 106 with a call placed to the communication interface 1314. In other examples, the communication interface 1314 may include one more APIs that provide fields for a recipient to enter information. The above communication features enable a recipient to request additional information related to the ERM and/or lien notice. Such a feature may also enable a recipient to request a change to the listed name and/or address, as described above in connection with FIGS. 1 to 12.

The example communication processor 1316 is configured to route the received communication from the recipient to a correct destination. For example, email messages maybe routed to an inbox of one or more operators for responding while SMS messages are routed to operators at an SMS application. Information entered via data fields may be routed to another operator while a live call is routed to yet another operator with a phone or video phone capability. In some instances, the operators may be replaced or supplemented with chat bots. The communication processor 1316 in some embodiments may relay certain information to the sender server 120 for direct contact regarding a status of an account.

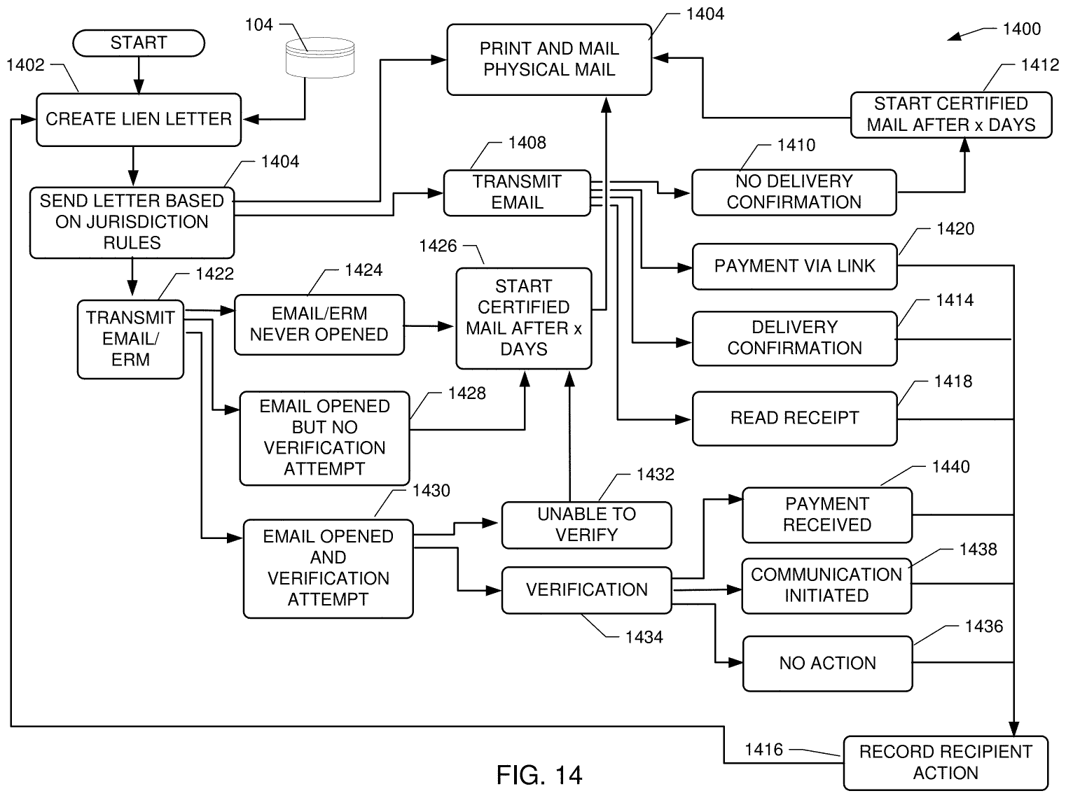

FIG. 14 shows a diagram of an example procedure 1400 that uses ERM for providing lien notices or notifications to recipients, according to an example embodiment of the present disclosure. The procedure begins 1400 after the management server 102 has received recipient information and account information from the sender server 120. In some embodiments, the management server 102 uses coding of one or more jurisdictional rules 1324 that is stored in the database 104 and overdue account information to determine when a lien letter or notice is to be created. Additionally or alternatively, the management server 102 receives a notification from the sender server 120 as to which recipients are to receive a lien notice.

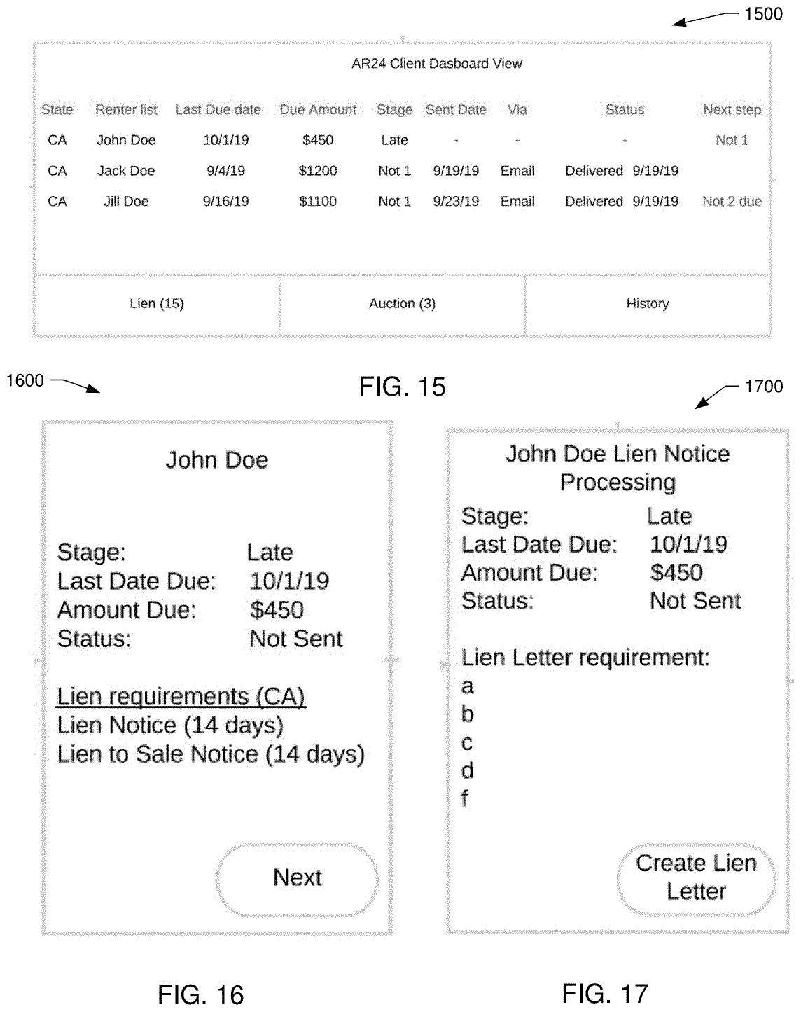

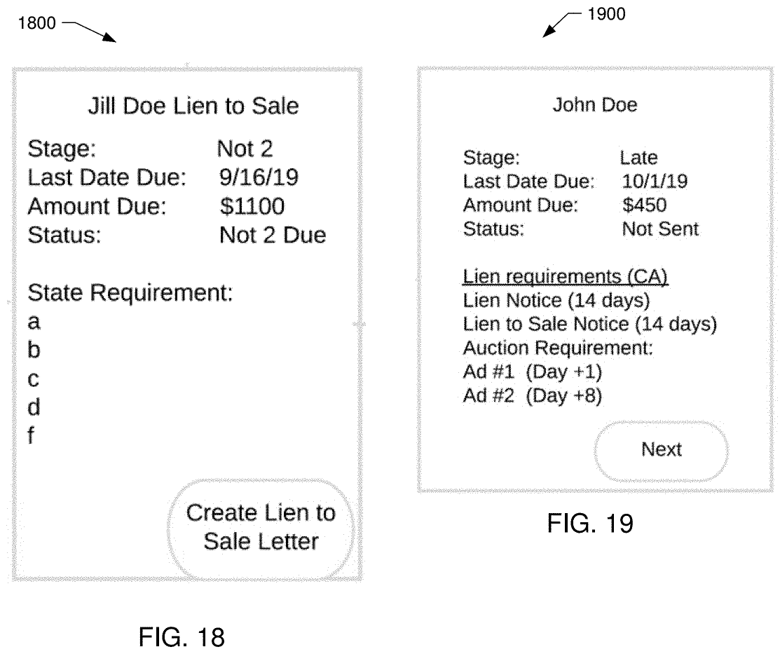

FIG. 15 shows a diagram of a dashboard 1500 provided by the management server 102 to the sender server 120 via the sender interface 1302. The dashboard 1500 includes recipient information, such as name and relevant state. The dashboard also includes account information, such as a due amount, due date, and stage of delinquency. As discussed in detail below, the dashboard 1500 may also provide tracking regarding dates that lien notices were sent, a method of delivery, a status of the delivery, and a next step, as allowed by the jurisdiction. The dashboard further shows which recipients are in a lien status and which recipients are in an auction or sale status.

Returning to FIG. 14, after determining that a recipient is to receive a lien notice, the management server 102 creates a lien letter (block 1402). As discussed above in connection with FIG. 13, the management server 102 accesses the template forms 1326 for the appropriate jurisdiction and populates the recipient information into the fields. The fields may include a recipient name/address, an original due date of the account, an amount owed, a new due date, account information, and/or content specification information from the sender server 120.

FIGS. 16 and 17 show intermediate forms and/or user interfaces 1600 and 1700 used by the management server 102 for creating a lien letter. The form or user interface 1600 includes the recipient name and account information, such as stage, due date, amount owned, and status. The form also includes lien rules or requirements for the jurisdiction, as specified by the coding of one or more jurisdictional rules 1324 in the database 104. The form or user interface 1700 shows another stage for generating the lien notice, where lien letter requirements are enumerated as (a) to (f). The form or user interface determines the requirements based on the coding of one or more jurisdictional rules 1324. The management server 102 processes the forms and/or user interfaces 1600 and 1700 into a lien notice.

Returning again to FIG. 14, the management server 102 then provides for transmission of the lien letter based on jurisdictional requirements and/or specification of the sender server 120 (block 1404). For instance, the sender server 120 may request that notices be provided with ERM if allowed by state law, and if not, via email instead. If the method of delivery is physical mail, the management server 102 causes the lien notice to print and be sent by physical mail, such as certified mail (block 1406). The management server 102 retains a copy of the tracking number and notes when a confirmation of delivery has been received.

If instead the method of delivery includes an email message (or SMS), the management server 102 provides the lien letter as an attachment to an email message (or SMS message) that is transmitted to the email address of the recipient (block 1408). If the email message (or SMS message) is returned to the management server 102 and/or delivery cannot be made (block 1410), the management server 102 waits a number of days specified by the jurisdiction in the coding of one or more jurisdictional rules 1324 to begin a certified mail process (block 1412). After the number of specified days have elapsed, the management server 102 causes the lien notice to print and be sent by physical mail, such as certified mail (block 1406).

If, however, the email message (or SMS message) is delivered but never opened (block 1414), the management server 102 is configured to note the delivery and lack of opening by recording the recipient action (block 1416). The management server 102 may also store the note to the database 104 in relation to the recipient and provide the information for display in the dashboard 1500. The management server 102 may then return to block 1402 for another lien letter to be generated, such as notice of sale.

Returning to block 1408, if the email message (or SMS message) is delivered and a read receipt is received (block 1418), the management server 102 is configured to note the delivery and read receipt by recording the recipient action (block 1416). The management server 102 may then return to block 1402 for another lien letter is to be generated, such as notice of sale since payment was not received. Again returning to block 1408, if the email (or SMS message) is delivered and payment information is received (block 1420), the management server 102 makes a note of the payment and/or amount by recording the recipient action (block 1416). The example procedure 1400 may then end for the specific recipient because the lien has been satisfied.

Returning to block 1404, if the transmission method is via ERM, the management server 102 creates the ERM, as discussed above, and provides the lien letter in conjunction with the ERM (block 1422). This may include withholding the lien letter until verification of the recipient's identity is achieved or unlocking the lien letter within the ERM (e.g., an ERM notification message) after verification of the recipient. Creation of the ERM may include creating an email message with the ERM or lien notice as contents of the email message, with the email message addressed the recipient.

If the management server 102 determines that the email message is not opened or otherwise returned (block 1424), the management server 102 waits a number of days specified by the jurisdiction in the coding of one or more jurisdictional rules 1324 to begin a certified mail process (block 1426). After the number of specified days have elapsed, the management server 102 causes the lien notice to print and be sent by physical mail, such as standard certified mail (block 1406).

If instead the management server 102 receives a confirmation that the email (e.g., the ERM notification message) was opened but the ERM verification process never began (block 1428), the management server 102 again waits a number of days specified by the jurisdiction in the coding of one or more jurisdictional rules 1324 to begin a certified mail process (block 1426). After the number of specified days have elapsed, the management server 102 causes the lien notice to print and be sent by physical mail, such as certified mail (block 1406).

On the other hand, if the recipient initiates the verification process of the ERM (block 1430), the management server 102 determines if the recipient can be verified using the methods discussed above. This may include providing the recipient a change to update their name and/or address, as discussed above in connection with FIGS. 1 to 13. If ultimately the recipient cannot be verified (block 1432), the management server 102 waits a number of days specified by the jurisdiction in the coding of one or more jurisdictional rules 1324 to begin a certified mail process (block 1426). After the number of specified days have elapsed, the management server 102 causes the lien notice to print and be sent by physical mail, such as certified mail (block 1406).

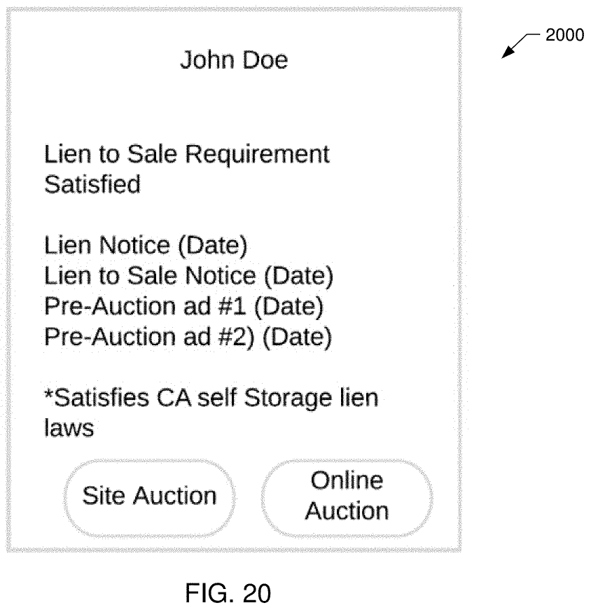

However, if the recipient can be verified (block 1434), the management server 102 is configured to enable the lien notice (e.g., contents of the ERM) to be displayed. This may include sending an unlocking message to the user device 106 of the recipient. Alternatively, this may include transmitting another email message to the recipient with the lien notice. If after verification, the recipient takes no action (block 1436), the management server 102 notes the inaction by recording the recipient action (block 1416). The management server 102 may also store the note to the database 104 in relation to the recipient and provide the information for display in the dashboard 1500. The management server 102 may then return to block 1402 for another lien letter to be generated, such as notice of sale or notice to an account provider that conditions for a sale/action have been satisfied, as discussed below in connection with FIG. 20.

If instead the management server 102 receives a communication message from the recipient (block 1438), the management server 102 processes and/or facilitates the communication. The goal of the communication session is to either rectify the outstanding balance or at least help the recipient and the account provider come to a consensus regarding the outstanding balance. The management server 102 notes the communication by recording the recipient action (block 1416). The management server 102 may also store the note to the database 104 in relation to the recipient and provide the information for display in the dashboard 1500. In some instances, the sender server 120 may modify account information based on the information, or at least remove the recipient from the list of overdue accounts. In other instances, no agreement may be reached such that the management server 102 may then return to block 1402 for another lien letter to be generated, such as notice of sale or notice to an account provider that conditions for a sale/action have been satisfied.

Returning to block 1434, if after verification the recipient provides payment (block 1440), the example management server 102 is configured to at least record a notice of the payment and/or amount by recording the recipient action (block 1416). In some instances, the management server 102 may process the payment if the ERM and/or lien letter include a payment hyperlink to a payment interface. Alternatively, the ERM and/or lien letter may provide for payment to be made by a third party, such as a financial institution. The example procedure 1400 may then end for the specific recipient because the lien has been satisfied.

As specified above, the example procedure 1400 may also be carried out for lien to sale notices. The example management server 102 may create an intermediary form or user interface 1900 for a lien to sale, as shown in FIG. 19. The form or user interface 1900 includes the recipient account information in addition to jurisdictional requirements for lien notices and auctions/sales. FIG. 20 shows a diagram of a form or user interface 2000 that may be provided to the sender server 120 when all the jurisdiction requirements for a lien sale are satisfied. The user interface 2000 may be created by the management server 102 into a report that is transmitted to the sender server 120. At this point, the account provider at the sender server 120 has evidence that the lien notification process was carried out according to jurisdictional rules and has evidence of the process being carried out, thereby limiting legal liability.

### Conclusion

It will be appreciated that each of the systems, structures, methods and procedures described herein may be implemented using one or more computer program or component. These programs and components may be provided as a series of computer instructions on any conventional computer-readable medium, including random access memory (“RAM”), read only memory (“ROM”), flash memory, magnetic or optical disks, optical memory, or other storage media, and combinations and derivatives thereof. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims. Moreover, consistent with current U.S. law, it should be appreciated that 35 U.S.C. 112(f) or pre-AIA 35 U.S.C. 112, paragraph 6 is not intended to be invoked unless the terms “means” or “step” are explicitly recited in the claims. Accordingly, the claims are not meant to be limited to the corresponding structure, material, or actions described in the specification or equivalents thereof.

The invention is claimed as follows:

1. An electronic registered mail (“ERM”) apparatus comprising:
at least one interface configured to receive, from a sender server, (i) recipient information for creating ERM for sending to a recipient, (ii) ERM content for the ERM, and (iii) at least one verification option, the recipient information including a recipient name, a recipient physical address, and a recipient email address;
a processor communicatively coupled to the at least one interface and configured to:
create an ERM notification message for the recipient by including the recipient name, the recipient physical address, and instructions for verification of the recipient based on the selected at least one verification option,
store a copy of the ERM to a memory device including at least one of the ERM notification message or the ERM content,
transmit the ERM notification message to the recipient email address,
receive verification information from a user device that accesses an email application for the recipient email address,
compare the verification information to at least some of the recipient information provided by the sender server or a unique code,
if the comparison is positive, cause the ERM content to be provided to the recipient, and
if the comparison is negative, prevent the ERM content from being provided to the recipient.

2. The apparatus of claim 1, wherein the ERM content includes at least one of a message, confidential information, a lien notification, legal information, personal information, an image, a video, or a hyperlink to a payment processor online system, a website, web form, or a server.

3. The apparatus of claim 1, wherein the processor is configured to include the ERM content with the ERM notification message and cause the ERM content to made available or unlocked if the comparison is positive.

4. The apparatus of claim 1, wherein the processor is configured to provide the ERM content separately from the ERM notification message and transmit at least one message with the ERM content to the email address of the recipient if the comparison is positive.

5. The apparatus of claim 1, wherein the processor is configured to store a record of the comparison in relation to the copy of the ERM in the memory device.

6. The apparatus of claim 1, wherein the processor is configured to transmit a message to the sender server that is indicative of the comparison or indicative as to whether the ERM content was provided to the recipient.

7. The apparatus of claim 1, wherein the at least one verification option includes at least one of receiving a code from a notary, recording an image of an identification card, recording video of the recipient holding an identification card, or live verification by an operator.

8. The apparatus of claim 7, wherein the processor is configured to include a verification submission feature with the ERM notification message, the submission feature configured based on the selected at least one verification option.

9. The apparatus of claim 8, wherein:
selection of the verification submission feature for the code from the notary causes the ERM notification message to open an interface on the user device with at least one field to accept the code from the notary for submission of the verification information;
selection of the verification submission feature for recording the image of the identification card causes the ERM notification message to open an interface on the user device with at least one field to accept a recorded image of the identification card of the recipient for submission of the verification information;
selection of the verification submission feature for recording the video of the recipient holding the identification card causes the ERM notification message to open an interface on the user device that provides instructions for the recipient to perform while being recorded and includes at least one field to accept the recorded video of the identification card of the recipient for submission of the verification information; and
selection of the verification submission feature for the live verification by an operator causes the ERM notification message to open an interface on the user device with a communication connection to an operator terminal that provides the verification information after the recipient has satisfied requests of the operator or the operator terminal provides the recipient the code for submission as the verification information.

10. The apparatus of claim 1, wherein the processor is configured to compare the verification information to at least some of the recipient information by:
performing at least one of a name recognition algorithm or a physical address recognition algorithm;
if a degree of similarity provided by the at least one of a name recognition algorithm or the physical address recognition algorithm is above a threshold, determine the comparison is positive; and
if the degree of similarity provided by the at least one of a name recognition algorithm or the physical address recognition algorithm is below the threshold, determine the comparison is negative.

11. The apparatus of claim 10, wherein the at least one of the name recognition algorithm or the physical address recognition algorithm includes at least one of a programming classics method for comparing characters, a Levenshtein method that determines a minimal number of characters needed to be replaced to create a match, an inclusion method that searches for name prefixes such as Mr. or Dr., an inversion of words method, an inversion of fields method, or combinations thereof to determine the degree of similarity between at least one of the recipient name and the recipient physical address.

12. The apparatus of claim 1, wherein the processor is configured to:
include a name change option in the ERM notification message;
receive from the user device after selection of the name change option, an amended recipient name;
transmit a message to the sender server that is indicative of the amended recipient name;
if an approval message is received from the sender server, create a second ERM including a second ERM notification message with the amended recipient name; and
transmit the second ERM notification message with the amended recipient name to the recipient email address.

13. The apparatus of claim 1, wherein the ERM content includes a lien notice or a lien to sale notice.

14. An electronic registered mail (“ERM”) apparatus for lien notifications comprising:
at least one interface configured to receive, from a sender server, (i) recipient information for creating ERM for sending to a recipient, (ii) overdue account information, and (iii) at least one verification option, the recipient information including a recipient name, a recipient physical address, and a recipient email address;
a memory device storing template forms for lien notices and coding for jurisdictional rules regarding lien notices; and
a processor communicatively coupled to the at least one interface and the memory device, the processor configured to:
determine a jurisdiction related to the recipient or the account of the recipient,
determine a lien notice is to be generated based on the coding for jurisdictional rules that are related to the determined jurisdiction and the overdue account information,
generate the lien notice for the recipient,
create an ERM notification message for the recipient by including the recipient name, the recipient physical address, and instructions for verification of the recipient based on the selected at least one option,
transmit the ERM message notification to the recipient email address,
receive verification information from a user device that accesses an email application for the recipient email address and views the ERM notification message,
compare the verification information to at least some of the recipient information provided by the sender server or a unique code,
if the comparison is positive, cause the lien notice to be provided electronically to the recipient, and
if the comparison is negative, cause the lien notice to be physically mailed to the recipient physical address.

15. The apparatus of claim 14, wherein the processor is configured to include the lien notice with the ERM notification message and cause the lien notice to be unlocked if the comparison is positive.

16. The apparatus of claim 14, wherein the processor is configured to provide the lien notice separately from the ERM notification message and transmit at least one message with the lien notice to the email address of the recipient if the comparison is positive.

17. The apparatus of claim 14, wherein the processor is configured to:
include a hyperlink to a payment processor in the lien notice;
after causing the lien notice to be provided to the recipient, receive an indication of a payment from the payment processor; and
update the overdue account information to reflect the payment by the recipient.

18. The apparatus of claim 17, the processor is configured to transmit a payment message to the sender server that is indicative of the payment.

19. The apparatus of claim 14, wherein the processor is configured to:
include a feature to initiate communication via at least one of a text message program, an email message program, or a phone program in the lien notice;
after causing the lien notice to be provided to the recipient, receive from the user device a communication via the at least one of the text message program, the email program, or the phone program; and
route the communication to an account or a queue of an operator for responding.

20. The apparatus of claim 14, wherein the processor is configured to:
include a name change option in the ERM notification message;
receive from the user device after selection of the name change option, an amended recipient name;
transmit a message to the sender server that is indicative of the amended recipient name; and
if an approval message is received from the sender server, verify the recipient or a substitute recipient using the received verification information and the amended recipient name.
